(19) United States
(12) Patent Application Publication
(10) Pub. No.: US 2026/0267302 A1
(43) Pub. Date: Sep. 10, 2026

(54) EVENT INFERRENCE

(71) Applicant: SANO DEVELOPMENT LIMITED, Wilmslow (GB)

(72) Inventors: Mohammed Benyezzar, Wilmslow (GB); Edward Ross Shenton, Wilmslow (GB)

(21) Appl. No.: 19/167,977

(22) PCT Filed: Feb. 15, 2024
(86) PCT No.: PCT/EP2024/053841

§ 371 Date: Sep. 23, 2025

(30) Foreign Application Priority Data
Mar. 23, 2023 (GB) 2304228.6
May 22, 2023 (GB) 2307642.5
Aug. 3, 2023 (GB) 2311947.2
Sep. 21, 2023 (GB) 2314499.1
Sep. 28, 2023 (GB) 2314919.8

(51) Int. Cl. G05B 15/02; G06N 5/04

(52) U.S. Cl. CPC G05B 15/02; G06N 5/04; G05B 2219/2642

(57) ABSTRACT

A method of inferring events within an indoor space. The method comprises receiving (801) sensor data from an environment sensor (101) within the indoor space, identifying (802) regions within the sensor data, and inferring (803) an event occurring within the indoor space based on an identified sequence of two or more identified regions. Each data region comprises a stable region (701,704) indicative of a period of time within which the received data does not vary by more than a magnitude threshold, a trend region indicative of a period of time within which the received data trends upwards or downwards with a sensor data gradient less than a gradient threshold, or a rapid change region (702, 703) indicative of a period of time within which the received data trends upwards or downwards with a sensor data gradient greater than or equal to the gradient threshold. A sensing system to perform the method comprises an environment sensor and a computing device. A calibration method and system are also disclosed.

### TECHNICAL FIELD

The present invention relates to a method of inferring the occurrence of events in an indoor space, a corresponding sensing system and related calibration methods and systems. Certain embodiments further allow for an indoor space state to be determined.

### BACKGROUND

Environment sensors, for instance temperature sensors, pressure sensors, humidity sensors, particulate matter sensors, a background pressure and differential pressure sensor a proximity or motion sensor, a light sensor, a distance or range sensor, or gas sensors (for instance those for sensing CO₂ or CO) are well known. Environment sensors, particularly temperature sensors, are commonly used in buildings including commercial, industrial and office buildings, and domestic premises (that is, houses and apartments, referred to in this document as homes). Environment sensors may be used to gather data for use in building control systems, for instance Heating, Ventilation and Air Conditioning (HVAC) systems, lighting systems, building mechanical control systems, or security systems (this list is not exhaustive). In some cases, environment sensors may directly control a building system, for instance, where a temperature sensor forms a thermostat for controlling a building heating system.

The use of sensors, for instance cameras and motion sensors, is a well-known approach to detect events within a building and to control building systems based on those events. An example of an event that may be detected using a camera or a motion sensor is a person entering or exiting an indoor space (for instance, a building room). A camera or motion sensor may also be used to detect a room state, for instance occupancy levels within a room. However, cameras and motion sensors are relatively expensive, particularly if used extensively throughout a building. Related to this the computing power and ancillary equipment required to process camera and motion sensor data to determine states and events may further add to the cost, besides system complexity and the need for maintenance. In some cases, particularly cameras may not be used due to privacy concerns and potential data breaches, especially in public buildings for instance hospitals or hotels. Furthermore, a range of sensor types may be required to detect various indoor space states (for instance, occupancy levels) and events within the indoor space (for instance, people or animals entering or exiting a room, doors or windows being opened or heating or cooling systems being activated or deactivated).

There is a recognised need for improved methods of monitoring the performance of a building over time, for instance monitoring its thermal efficiency to detect for changes indicative of degradation of the building fabric over time. However, known techniques are limited in their ability to take account of how the building is used and how changing patterns of building use might impact on the building performance.

It is an aim of certain examples of the present invention to solve, mitigate or obviate, at least partly, at least one of the problems and/or disadvantages associated with the prior art. Certain examples aim to provide at least one of the advantages described below.

### BRIEF SUMMARY OF THE INVENTION

Embodiments of the present invention are described in connection with the inference of events occurring in an indoor space. An indoor space may be a building or part of a building for instance a room. The term “building” should be broadly construed to mean any structure defining a space which is wholly or partially contained, and “indoor space” should similar be construed as meaning any space that is wholly or partially contained, for instance within a building.

According to an aspect of the present invention there is provided a method of inferring events within an indoor space, the method comprising: receiving sensor data from an environment sensor within the indoor space; identifying regions within the received sensor data, each region comprising: a stable region indicative of a period of time within which the received data does not vary by more than a magnitude threshold; a trend region indicative of a period of time within which the received data trends upwards or downwards with a sensor data gradient less than a gradient threshold; or a rapid change region indicative of a period of time within which the received data trends upwards or downwards with a sensor data gradient greater than or equal to the gradient threshold; and inferring an event occurring within the indoor space based on an identified sequence of two or more identified regions.

The inference may be based on a calibration method comprising: receiving sensor data from the environment sensor within the indoor space during a plurality of known events within the indoor space; identifying regions within the received sensor data, each region comprising: a stable region indicative of a period of time within which the received data does not vary by more than a magnitude threshold; a trend region indicative of a period of time within which the received data trends upwards or downwards with a sensor data gradient less than a gradient threshold; or a rapid change region indicative of a period of time within which the received data trends upwards or downwards with a sensor data gradient greater than or equal to the gradient threshold; and correlating an identified sequence of regions within the sensor data to those known events within the indoor space.

According to a further aspect of the present invention there is provided a computer-implemented method for characterising an indoor space, the method comprising: receiving sensor data from an environment sensor within an indoor space; identifying within the received sensor data at least one: stable region indicative of a period of time within which the received data does not vary by more than a magnitude threshold; trend region indicative of a period of time within which the received data trends upwards or downwards with a sensor data gradient less than a gradient threshold; or rapid change region indicative of a period of time within which the received data trends upwards or downwards with a sensor data gradient greater than or equal to the gradient threshold; and inferring at least one of an indoor space state or an event occurring within the indoor space based on the identification.

Advantageously a relatively low-cost environment sensor, for instance a single temperature sensor, may be used in an indoor space to infer an event occurring within the indoor space. In some cases, the same sensor may be used as well or instead to infer an indoor space state. For instance, a temperature sensor may be located within an indoor space, for instance a room in a domestic premises, and events for instance people entering or exiting the room or doors or windows being opened or closed may be inferred. Additionally, or alternatively, room state information for instance the number of people present, and which heat sources are activated or deactivated may be inferred. In some examples this inference of indoor space state or events is based on a prior calibration process for the environment sensor situated in a particular location within the indoor space.

According to a yet further aspect of the present invention there is provided a computer-readable storage medium having computer-readable program code stored therein that, in response to execution by a processor, causes the processor to perform the above characterisation method.

According to a yet further aspect of the present invention there is provided an apparatus comprising a processor and a memory storing executable instructions that, in response to execution by the processor, cause the apparatus to perform the above characterisation method.

According to a yet further aspect of the present invention there is provided a sensing system for characterising an indoor space, in some aspects specifically for inferring events within the indoor space, the system comprising: an environment sensor configured to generate sensor data indicative of an environment parameter within the indoor space; and a computing device configured to: receive sensor data from the environment sensor; identify regions within the received sensor data, each region comprising: a stable region indicative of a period of time within which the received data does not vary by more than a magnitude threshold; a trend region indicative of a period of time within which the received data trends upwards or downwards with a sensor data gradient less than a threshold gradient; or a rapid change region indicative of a period of time within which the received data trends upwards or downwards within a sensor data gradient greater than or equal to a threshold gradient; and infer an event occurring within the indoor space based on an identified sequence of two or more identified regions, or infer one of an indoor space state or an event occurring within the indoor space based on the identification.

According to a yet further aspect of the present invention there is provided a method for calibrating a method of inferring events within an indoor space, the method comprising: receiving sensor data from an environment sensor within the indoor space during a plurality of known events within the indoor space; identifying regions within the received sensor data, each region comprising: a stable region indicative of a period of time within which the received data does not vary by more than a magnitude threshold; a trend region indicative of a period of time within which the received data trends upwards or downwards with a sensor data gradient less than a gradient threshold; or a rapid change region indicative of a period of time within which the received data trends upwards or downwards with a sensor data gradient greater than or equal to the gradient threshold; and correlating an identified sequence of regions within the sensor data to known events within the indoor space.

According to a yet further aspect of the present invention there is provided a computer-implemented method for calibrating the characterisation of an indoor space, the method comprising: receiving sensor data from an environment sensor within an indoor space; observing indoor space states or events within the indoor space; and correlating sensor data to observed indoor space states or events within the indoor space.

There is further disclosed a computer-readable storage medium having computer-readable program code stored therein that, in response to execution by a processor, cause the processor to perform the above calibration method.

There is further disclosed an apparatus comprising a processor and a memory storing executable instructions that, in response to execution by the processor, cause the apparatus to perform the above calibration method.

According to a yet further aspect of the present invention there is provided a sensing system for calibrating a method of inferring events within an indoor space, the system comprising: an environment sensor configured to generate sensor data indicative of an environment parameter within the indoor space; and a computing device configured to: receive sensor data from the environment sensor during a plurality of known events within the indoor space; identify regions within the received sensor data, each region comprising: a stable region indicative of a period of time within which the received data does not vary by more than a magnitude threshold; a trend region indicative of a period of time within which the received data trends upwards or downwards with a sensor data gradient less than a gradient threshold; or a rapid change region indicative of a period of time within which the received data trends upwards or downwards with a sensor data gradient greater than or equal to the gradient threshold; and correlate an identified sequence of regions within the sensor data to known events within the indoor space.

According to a yet further aspect of the present invention there is provided a sensing system for calibrating the characterisation of an indoor space, the system comprising: an environment sensor configured to generate sensor data indicative of an environment parameter within an indoor space; and a computing device configured to: receive sensor data from the environment sensor; observe indoor space states or events within the indoor space; and correlate sensor data to observed indoor space states or events within the indoor space.

Further aspects of the present invention are defined by the appended claims.

There is further disclosed a method of controlling a system within a building, the method comprising: receiving sensor data from an environment sensor within a room in a building; identifying stable regions and change regions within the received sensor data; and inferring at least one of a room state or an event occurring within the room based on the identification; wherein the method further comprises: controlling a building system based upon the inferred room state or event; or supplying information to a building control system for controlling the building system based upon the inferred room state or event; and wherein the environment sensor comprises one or more of: a temperature sensor; a pressure sensor; a particulate matter sensor; a humidity sensor; or a gas sensor.

The term “building” includes industrial, commercial, retail and office buildings or structures as well as domestic premises including houses and apartments (that is, homes). However, as will become apparent from the following description, the disclosed method for controlling a system within a building is particularly suited to monitoring or controlling building systems within homes. The terms “room” or “room within a building” should be broadly construed to encompass any indoor space that is fully or partially enclosed within a building. Of particular interest is indoor living space. Where reference is made in the following description, for instance to “characterising an indoor space” this should be construed to include characterising a room within a building.

An advantage of the above method is that a relatively low-cost environment sensor may be used to identify a room state or event, for instance the number of occupants or when people enter or leave a room, which may be used to control a building system. An example of this is using room occupant information to control a heating system for increased comfort of the occupants or to increase energy efficiency (for instance by turning off heating in unoccupied rooms).

Controlling a building system may comprise generating a control signal to control at least one component within a building system; or generating an output signal indicative of a building system state.

The control signal may instruct at least one component of a building system to turn on or off; to adjust a set parameter; or to change a mode of operation; or the supplied information may indicate to the building control system that at least one component of a building system should be turned on or off; have a set parameter adjusted; or have a mode of operation changed.

The building system may comprise one or more selected systems or a combination of systems from a group including: a building ventilation system; a building heating system; a building air conditioning system; a building security system; a building lighting system; or a building mechanical control system. Controlling a building system based upon the inferred room state or event may comprise controlling one or more of: a ventilation fan; a ventilation valve; a heating control, output device or valve; an air conditioning control, output device or valve; a light; a security alarm, security light or security output signal to a remote device or monitoring service; or a building mechanical actuator.

Where the environment sensor is a temperature sensor the method may further comprise using the sensed temperature as a thermostat input for a building heating system. Where the environment sensor is a temperature sensor, an inferred room space state may comprise a state in which the number of heat sources and heat sinks within the room remains static. Where the environment sensor is a temperature sensor, an inferred event that has occurred within the room 35 may comprise one of: a heat source entering or being activated in the room; or a loss of heat being triggered in the room.

A heat source entering or being activated in the room may comprise: an artificial heating system being activated within the room; or a person or animal entering the room. A loss of heat being triggered in the room may comprise: an artificial cooling system being activated in the room; an artificial heating system being deactivated within the room; an aperture, for instance a door or window, being opened allowing warm air to vent from the room; or a person or animal leaving the room.

The method may further comprise determining occupancy information in respect of the room based upon the inferred room state or event; and controlling the building system based upon the determined occupancy information.

The method may further comprise receiving sensor data from a plurality of environment sensors located within a plurality of rooms in a building; identifying stable regions and change regions within the received sensor data in respect of each room; inferring at least one of a room state for each respective room or an event occurring within each respective room based on the identification; and controlling a building system based upon the inferred room states or events in respect of each room.

The method may further comprise determining occupancy information in respect of each room based upon the inferred room states or events; and controlling the building system based upon the determined occupancy information for each room. Controlling the system may comprise controlling the building system differently in respect of at least two rooms based upon the inferred room states or events in respect of those rooms.

The method may further comprise receiving data indicative of whether a door or a window opening onto at least one room with an environment sensor is open; wherein the control of a building system is further based on the received data.

The method may further comprise predicting future occupancy of a room within a building based on determined occupancy and controlling the building system based on predicted future occupancy.

Identifying stable regions and change regions within the received sensor data may comprise identifying within the received sensor data at least one: stable region indicative of a period of time within which the received data does not vary by more than a magnitude threshold; trend region indicative of a period of time within which the received data trends upwards or downwards with a sensor data gradient less than a gradient threshold; or rapid change region indicative of a period of time within which the received data trends upwards or downwards with a sensor data gradient greater than or equal to the gradient threshold.

Prior to the step of identification, the method may further comprise filtering the sensor data. The filtering may comprise noise reduction and removal of fluctuations not indicative of change within the room. The filtering may comprise passing the sensor data through a weighted window processing filter. Prior to the step of identification, the method may further comprise curve fitting the sensor data or filtered sensor data to a polynomial curve. The sensor data or filtered sensor data may be fitted to a polynomial curve with an order of two or more. Identifying a stable region, trend region or rapid change region may comprise processing the sensor data, filtered sensor data or curve fitted sensor data using a region weighting mathematical expression.

For at least one identified stable region, inferring a room state may comprise: identifying a sensor data magnitude or an average sensor data magnitude within the identified stable region; identifying a sensor data magnitude band containing the sensor data magnitude or average magnitude; and inferring a room state based on the identified sensor data magnitude band; wherein the inference of a room state is based on a prior calibration process of measuring sensor data magnitudes for a plurality of known room states and determining sensor data magnitude bands for those known room states.

For at least one trend region the method further may comprise: inferring that no event has occurred within the room state or that the room remains within a previously identified room state based on a prior calibration process of measuring sensor data magnitudes for a plurality of known room states and determining expected data trends or drifts in sensor data for those known room states over time.

For at least one identified rapid change region inferring an event occurring within the room may comprise: identifying a sensor data gradient or an average sensor data gradient within the identified rapid change region; identifying a sensor data gradient band containing the sensor data gradient or average gradient; and inferring that an event that has occurred within the room based on the identified sensor data gradient band; wherein the inference of an event that has occurred within the room is based on a prior calibration process of measuring sensor data gradients for a plurality of known events within the room and determining sensor data gradient bands for those known events within the room.

Inferring an event that has occurred within the room may be further based upon an identified sequence of two or more different rapid change regions. Inferring an event that has occurred within the room may be further based upon an identified sequence of two or more different rapid change regions having opposite polarity sensor data gradients. Inferring an event that has occurred within the room may be further based upon an identified sequence of one or more stable regions or trend regions and one or more rapid change regions.

There is further disclosed a computer-readable storage medium having computer-readable program code stored therein that, in response to execution by a processor, causes the processor to perform the above method. There is further disclosed an apparatus comprising a processor and a memory storing executable instructions that, in response to execution by the processor, cause the apparatus to perform the above method.

There is further disclosed a control system for controlling a system within a building, the control system comprising: an environment sensor configured to generate sensor data indicative of an environment parameter within a room in a building; and a computing device configured to: receive sensor data from the environment sensor; identify stable regions and change regions within the received sensor data; and infer at least one of a room state or an event occurring within the room based on the identification; wherein the computing device is further configured to: control a building system based upon the inferred room state or event; or supply information to a building control system for controlling the building system based upon the inferred room state or event; and wherein the environment sensor comprises one or more of: a temperature sensor; a pressure sensor; a particulate matter sensor; a humidity sensor; or a gas sensor.

The control system may further comprise: a plurality of environment sensors, each environment sensor being located within a separate room within a building and generating sensor data indicative of an environment parameter and providing the sensor data to the computing device; wherein the computing device may be further configured to: identify stable regions and change regions within the received sensor data in respect of each room; infer at least one of a room state for each respective room or an event occurring within each respective room based on the identification; and control a building system based upon the inferred room states or events in respect of each room.

A separate computing device may be associated with each environment sensor and configured to perform at least part of the processing to infer at least one of a room state or an event occurring within the room.

The control system may further comprise a building system controller configured to: receive data from a computing device associated with each environment sensor, the data being indicative of an environment parameter; identified stable regions and change regions within the sensor data; or inferred room states or events occurring within the room; and control a building system based upon the inferred room states or events in respect of each room.

The computing device or the building system controller may be further configured to perform the above method.

There is further disclosed another method of inferring events within an indoor space, the method comprising: receiving sensor data from two or more environment sensors within the indoor space; dividing the sensor data into a series of time periods; for each time period and for at least two environment sensors, forming a classification pattern by classifying the sensor data for each sensor into two or more states; and for each time period, inferring an event occurring within the indoor space based on the classification pattern.

For each sensor the sensor data may be classified into three states comprising rising sensor data, falling sensor data or steady sensor data.

Sensor data may be classified as rising sensor data if it increases by more than a first threshold during a time period; wherein sensor data is classified as falling sensor data if it decreases by more than a second threshold during a time period; and otherwise, sensor data is classified as steady sensor data.

For each sensor the sensor data may be classified into five states comprising rising sensor data, rapidly rising sensor data, falling sensor data, rapidly falling sensor data, or steady sensor data by comparing the sensor data to two different thresholds for rising sensor data and two different thresholds for falling sensor data.

For each time period, inferring an event may comprise comparing the classification pattern to historical data comprising classification patterns for a plurality of known event types, wherein the historical data is generated through a process of receiving sensor data during a plurality of known events within the indoor space and for each known event correlating the event to a classification pattern for a time period containing that event.

The historical data may be stored in a look up table.

Comparing the classification pattern to historical data may further comprise interpolation to determine an inferred event if the historical data does not contain an exact classification pattern match.

The method may further comprise updating the historical data to include the event inferred through interpolation and the associated classification pattern.

The method may further comprise for a current time period determining the number of sensor state changes within a current classification pattern relative to a preceding classification pattern for the preceding time period and only comparing the current classification pattern to historical data if the number of sensor state changes is one or more.

The two or more environment sensors may comprise a plurality of sensors configured to measure the same environmental parameter; or wherein two or more sensors are configured to measure different environmental parameters.

The two or more environment sensors may be collocated within the indoor space. Alternatively, the two or more environment sensors may be spaced apart within the indoor space.

Each time period may be equal in length; and the time period length may be longer than the time taken for an event to result in a sensor data change for each sensor.

For a specific indoor space, the length of each time period may be configurable according to the anticipated duration of events.

The method may further comprise inferring an event based on classification patterns for two or more consecutive time periods.

The method may further comprise for sensor data received from one of the environment sensors: identifying regions within the received sensor data, each region comprising: a stable region indicative of a period of time within which the received data does not vary by more than a magnitude threshold; a trend region indicative of a period of time within which the received data trends upwards or downwards with a sensor data gradient less than a gradient threshold; or a rapid change region indicative of a period of time within which the received data trends upwards or downwards with a sensor data gradient greater than or equal to the gradient threshold; and inferring an event occurring within the indoor space based on an identified sequence of two or more identified regions.

A computer-readable storage medium may be provided having computer-readable program code stored therein that, in response to execution by a processor, cause the processor to perform any one of the above methods.

An apparatus may be provided comprising a processor and a memory storing executable instructions that, in response to execution by the processor, cause the apparatus to perform any one of the above methods.

A sensing system may be provided for inferring events within an indoor space, the system comprising: two or more environment sensors configured to generate sensor data indicative of one or more environment parameter within the indoor space; and a computing device configured to: receive sensor data from the environment sensors; divide the sensor data into a series of time periods; for each time period and for at least two environment sensors, form a classification pattern by classifying the sensor data for each sensor into two or more states; and for each time period, infer an event occurring within the indoor space based on the classification pattern.

There is further disclosed a method of monitoring a building, the method comprising: receiving sensor data from an environment sensor within a room in the building; inferring at least one of a room state or an event occurring within the room using the sensor data; forming a data set including the sensor data and inferred room states or events; and analysing the data set to monitor building condition or performance.

The inferred room event may comprise a change in room occupancy. The inferred room state may comprise room occupancy information correlated with the sensor data. Room occupancy information may comprise: an indication of whether the room is occupied or unoccupied; or an indication of the current number of people within the room.

The data set may further comprise time information for sensor data and time information for inferred room states and events. The data set may comprise sensor data and inferred room states or events for two or more rooms within a building. The data set may further comprise sensor data received from a plurality of environment sensors; and the plurality of environment sensors may comprise at least one of: two or more different environment sensor types; and two or more environment sensors distributed within one or more rooms within the building.

The environment sensor may comprise at least one sensor selected from a group including: a temperature sensor; a pressure sensor; a humidity sensor; a particulate matter sensor; a gas sensor; or a light sensor.

The method may further comprise: reducing the granularity of sensor data, room state or event information in the data set. Data granularity may be reduced by averaging the data over a predetermined time period.

The data set further comprise: data indicative of whether a door or a window opening onto a room with an environment sensor is open or closed; data indicative of a location of an environment sensor within a building; data indicative of room or building layout, dimensions or configuration; environment data for the ambient environment outside of the building; weather data for the building location; data indicating energy consumption information for the building; or data indicating energy consumption information for a heating or ventilation system within the building.

Inferring at least one of a room state or an event occurring within the room may comprise: identifying stable regions and change regions within the received sensor data; and inferring at least one of a room state or an event occurring within the room based on the identification.

An inferred event that has occurred within the room may comprise one of: a heat source entering or being activated in the indoor space; or a loss of heat being triggered in the room.

A heat source entering or being activated in the indoor space may comprise: an artificial heating system being activated within the indoor space; an artificial cooling system being deactivated in the indoor space; a door or window being opened; or a person or animal entering the indoor space.

A loss of heat being triggered in the room may comprise: an artificial cooling system being activated in the indoor space; an artificial heating system being deactivated within the indoor space; a door or window being opened; or a person or animal leaving the indoor space.

Analysing the data set to monitor building condition or performance may comprise:
detecting a change in building condition or performance according to whether the building is occupied or unoccupied determined through inferred room state or event information.

Analysing the data set to monitor building condition or performance may comprise: using inferred room occupancy information to exclude the effects of changes in occupancy from environmental sensor data for the building or a room within the building.

Analysing the data set to monitor building condition or performance may comprise: detecting a change in building condition or performance; and in response to detecting a change, providing an output indicating a need for a building inspection or corrective action.

Detecting a change in building condition or performance may comprise: determining a measure of building thermal efficiency based on energy consumption information, sensor data from one or more temperature sensor within the building, and temperature data for the ambient environment outside of the building; and detecting a change in building thermal efficiency between first and second time points.

The method may further comprise: transmitting at least part of the data set to a remote server; and performing at least part of the data set analysis at the remote server.

The method may further comprise: aggregating data sets for two or more buildings; and analysing the aggregated data set to monitor aggregated building condition or performance.

According to a second aspect of the present invention there is provided a system for monitoring a building, the system comprising: at least one environment sensor within a room in the building; and a processor associated with the building and configured to: receive sensor data from the environment sensor; infer at least one of a room state or an event occurring within the room using the sensor data; form a data set including the sensor data and inferred room states or events; and analyse the data set to monitor building condition or performance.

According to a third aspect of the present invention there is provided a system for monitoring a building, the system comprising: at least one environment sensor within a room in the building; a processor associated with the building; and a remote server; wherein the processor associated with the building is configured to: receive sensor data from the environment sensor; infer at least one of a room state or an event occurring within the room using the sensor data; form a data set including the sensor data and inferred room states or events; and transmit the data set to a remote server; and wherein the remote server is configured to analyse the data set to monitor building condition or performance.

### BRIEF DESCRIPTION OF THE DRAWINGS

Examples of the invention are further described hereinafter with reference to the accompanying drawings, in which:

FIG. 1 schematically illustrates a sensing system for characterising a room state or for calibrating the characterisation according to an embodiment of the present invention;

FIG. 2 is a perspective view of a hybrid home;

FIG. 3 is a plan view of the hybrid home of FIG. 2 in which the sensing system of FIG. 1 is deployed in a room according to an embodiment of the present invention;

FIG. 4 is a graph showing raw data received from a temperature sensor forming part of the sensing system of FIG. 1 according to an embodiment of the present invention;

FIG. 5 is a graph showing the raw data for FIG. 4 and the raw data after filtering according to an embodiment of the present invention;

FIG. 6 is a graph showing the filtered data of FIG. 5 and a curved fitted to the filtered data according to an embodiment of the present invention;

FIG. 7 is a graph showing the curved fitted data of FIG. 6 after regions of interest have been identified according to an embodiment of the present invention;

FIG. 8 is a flowchart illustrating a method for characterising a room state or inferring an event according to an embodiment of the present invention;

FIG. 9 is a flowchart illustrating a method for characterising a room state or inferring an event according to an embodiment of the present invention;

FIG. 10 is a flowchart illustrating a method for calibrating a system for characterising a room state or inferring an event according to an embodiment of the present invention;

FIG. 11 is a flowchart illustrating a method for calibrating a system for characterising a room state or inferring an event according to an embodiment of the present invention;

FIG. 12 schematically illustrates a sensor forming part of the sensing system of FIG. 1;

FIG. 13 schematically illustrates a computing device forming part of the sensing system of FIG. 1;

FIG. 14 is a flowchart illustrating a method of controlling a building system using a single sensor;

FIG. 15 is a plan view of a home in which a sensing system is deployed with a sensor in each room;

FIG. 16 is a flowchart illustrating a method of controlling a building system using multiple sensors as deployed in separate rooms in accordance with FIG. 15;

FIG. 17 illustrates the heat released to a room during a rapid change region, according to an embodiment of the invention;

FIG. 18 is a flowchart illustrating a method for inferring an event according to an embodiment of the present invention;

FIG. 19 schematically illustrates a first system for monitoring a building system implementing the method of FIG. 18 according to an embodiment of the invention; and

FIG. 20 schematically illustrates a second system for monitoring a building system implementing the method of FIG. 18 according to an embodiment of the invention.

### DETAILED DESCRIPTION

The present invention concerns a method and a sensing system for characterising an indoor space, particularly by inferring the occurrence of an event within the indoor space. Examples are given whereby this characterisation of an indoor space may be used for controlling a building system. In certain examples the building system may be a building heating, cooling, ventilation, lighting, or security system. In the following description the term room is used, particularly a room in a building for instance a domestic premises, however embodiments of the present invention are applicable to any indoor space. The characterisation of the indoor space uses data from an environment sensor, for instance a temperature sensor, a pressure sensor, a humidity sensor, a CO₂ sensor, a particulate matter sensor, a background pressure and differential pressure sensor, a proximity or motion sensor, a light sensor, or a distance or range sensor. Raw sensor data is processed and used to infer a room state or an event that has taken place or is currently taking place within the room.

Certain embodiments of the present invention are particularly suited to the detection and identification of human presence and related movements within a living space in a home using a temperature sensor. This may be used to control a building system based on the detected presence and movement. Certain embodiments assess the thermal data from a temperature sensor for both magnitude and gradient indicating a thermal gradient within the room with high precision. Certain embodiments of the present invention also allow the presence or absence of heat sources to be inferred or for thermal variations caused through heat gain/loss appliances, by drafts and leaks or the opening or closing of a window or door to be inferred and a building system to be controlled accordingly.

Stated broadly, the present invention allows information to be used to infer room states and room events using data from substantially any environment sensor. In the discussion below concerning characterising a room and a calibration process, the type of sensing is considered broadly. However, the present inventor has identified that a temperature sensor with a high precision is particularly suited to detecting changes to the thermal envelope of a room. Such a thermal sensor can sense a thermal background of a room and dynamic heat sources, including heat sources with a low heat footprint. From this sensed thermal data, information can be inferred (based on a prior calibration process). This inferred information is particularly pertinent for the control of building systems as detected thermal changes may be used, for instance, to identify the number of people present or entering a room which is of direct use, for instance to control a building heating system in that room. Accordingly, in some of the examples presented below, specific reference is made to sensing thermal changes. However, the skilled person will immediately appreciate that the methodology set out in these examples is more generally applicable to other sensor types (unless the specific context requires that that methodology is restricted to temperature sensing).

For the example of thermal sensing, each internal space for instance a room can be calibrated to identify sources of heat or their absence, and particularly changes in heat sources within a room, through measurement of the thermal state of the room. Sources of heat are identified through their energy or heat release which is captured by a precision thermal sensor. The sensor is place in a salient position in the typical room (4 m×3 m) and calibrated against various events known or observed to have taken place in the room. For instance, events may be enacted within the room and sensor data during the time period of the known event used for the calibration. This may comprise manually or automatically tagging portions of sensor data during the time period of a known event. This time period may include a period of time preceding the event to serve as a baseline sensor reading and a period of time after the event sufficiently long enough to enable sensor readings to have stabilised. In spaces that are identical in footprint such calibration may be similar in details and values for the expected heat loads. The identification of the thermal status for each room may be used, for instance, to control the heating system used for the overall space. The heat loads identified are used to reduce or increase heating level within either the individual rooms or the overall space inhabited.

Similarly, other sensor types may yield similar information as set out below:

A pressure sensor may be used to control a building system using barometric sensing with high precision (Pascal level). Such a sensor may sense background pressure and dynamic pressure source with a low “partial” pressure profile or change to overall pressure.

A background pressure and differential air pressure sensor may be used to control a building system using the measurement of mass flow of air (N₂ and O₂) in a directional manner. This may reveal local air currents and any air disturbances within the space. This in turn may reveal the presence or absence of air currents for best ventilation assessment. This can be combined with other types of sensors to provide presence of people/pets/objects, and general living space status.

A humidity sensor may be used to control a building system using sensed moisture in the air. By sensing humidity with high precision changes in humidity may be correlated to a room condition. With sufficient precision of measurement, humidity from perspiration or breathing of a room occupant may be detected. Small changes in humidity can be identified, resulting in it being possible to take prompt action (for instance, to adjust ventilation in the room).

A CO₂ sensor may be used to control a building system using changes in CO₂ resulting from perspiration or breathing. Additionally, CO₂ emitting sources may be sensed. Changes in CO₂ may outline levels of occupation by people, emissions from fires, heated objects, and hazardous levels due to fires or smoke. Lower CO₂ values may reveal closed spaces or good ventilation levels which can be used as a reference.

A particulate matter sensor (sometimes referred to as an air quality sensor) may be used to control a building system using a count of the number of particles in the air (including their distribution). Particulate matter levels may be recorded as per defined standards to infer levels of air quality. Furthermore, changes in presence, movement of people/pets, rising temperature, sunshine, vacant spaces, air currents and their direction as well as still pockets may be detected.

For embodiments of the present invention that do relate specifically to thermal sensing, the present invention allows for thermal changes due to the presence or absence of a thermal source for instance a human body or similar (or more than one body) or slow changes or drifts in temperature within the living space and which can be due to slow heat gain or loss phenomena and any changes from a steady state caused by these. These outlined phenomena can be caused by: presence or absence (use and non-use) of heat sources and building cooling systems or the appearance of heat loss phenomena (heat leakage/loss and absence or switch off of heaters, warm air etc.), drafts caused either by heat loss (bad insulation/thermal performance), local actions for instance door or window opening/closure, the presence of a person in the living space and increase or decrease in the number of persons, detection of subsequent actions for instance door opening/closure, window opening/closure, person or persons accessing the living space.

Heat gain sources include a person or persons, a heater or more, a draft or heat loss occurrences. The gains outline an increase with respect to heat when the sources are exhibiting a warmer output than the current temperature of the living space and they outline a decrease when for example a cooling appliance is used, or a heat loss device or object is present or activated.

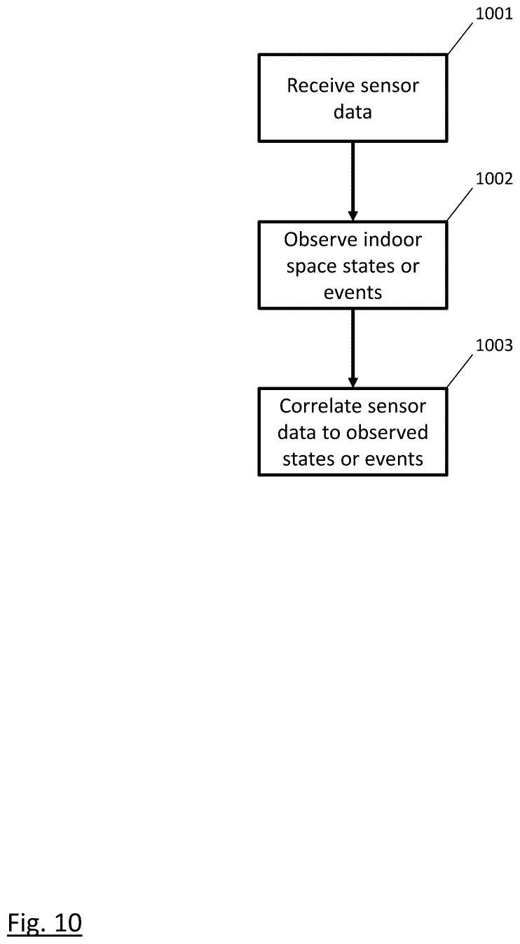

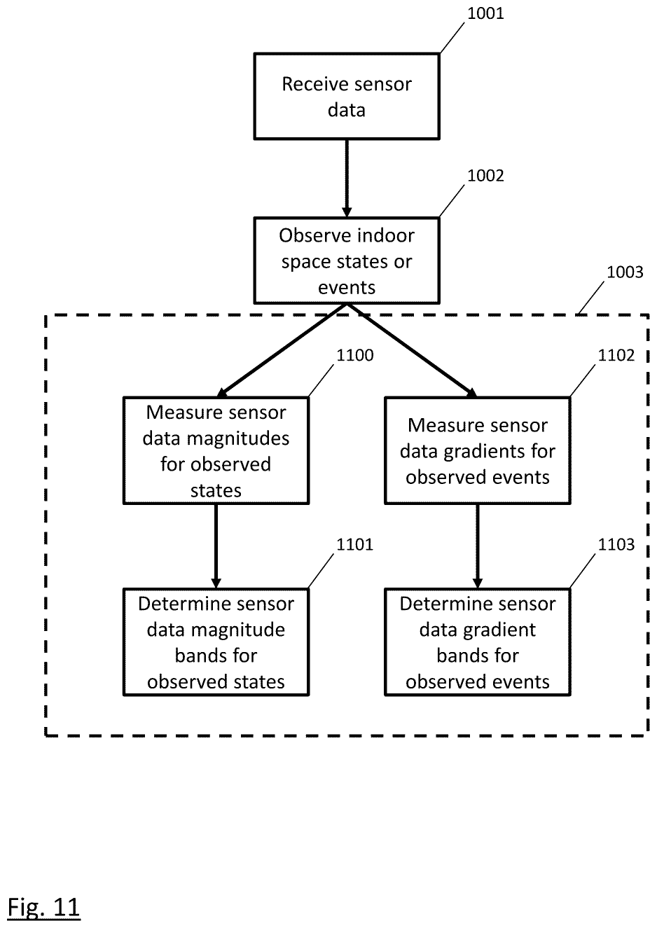

As will be described below in connection with FIGS. 4 to 7 data from an environment sensor is signal processed to remove noise and irrelevant data fluctuations, the filtered data is fitted to a curve and a mathematical identification process is applied. The identification process identifies regions within the received sensor data. Each region comprises: a stable region indicative of a period of time within which the received data is relatively stable within a first sensor data magnitude band; a trend region indicative of a period of time within which the received data trends upwards or downwards within a first sensor data gradient band; or a rapid change region indicative of a period of time within which the received data trends upwards or downwards within a second sensor data gradient band. For an identified stable region, trend region or rapid change region it is possible to infer an indoor space state for instance the number of people present within the room or whether an artificial heat source is activated, as will be described below. For an identified stable region, trend region or rapid change region it is also possible to infer whether an event has occurred within the indoor space and the nature of the event. As is described in greater detail below, according to certain embodiments of the present invention, the inference of an event is based on a sequence of two or more identified regions in the sensor data. The sequence may comprise a concatenation of multiple regions. The sequence may comprise two or more dissimilar types of region, for instance a stable region followed by a rapid change region, optionally followed by a second, different stable region. The sequence may compromise two more regions of the same type, for instance a first rapid change region followed by a second rapid change region (for the example of a temperature sensor, this could be a rapid increase in temperature followed by a rapid decrease in temperature). The inference of an event and the discrimination of the type of event may comprise identifying the type of regions in the sequence and using this information to access a look-up table or other form of database created during the calibration process. The event inference and discrimination may further comprise quantifying each region in the sequence in some way, for instance by a magnitude band for a stable region or a trend region or a gradient band for a rapid change region and again using this information to access a look-up table. The event inference and discrimination may further comprise determining a data change during a data region or between two regions, for instance a magnitude change or a change in magnitude bands where a sequence of regions comprises a first stable region, a rapid change region and a second stable region. In certain embodiments this inference is based on a prior calibration process, as is described below in connection with FIGS. 10 and 11.

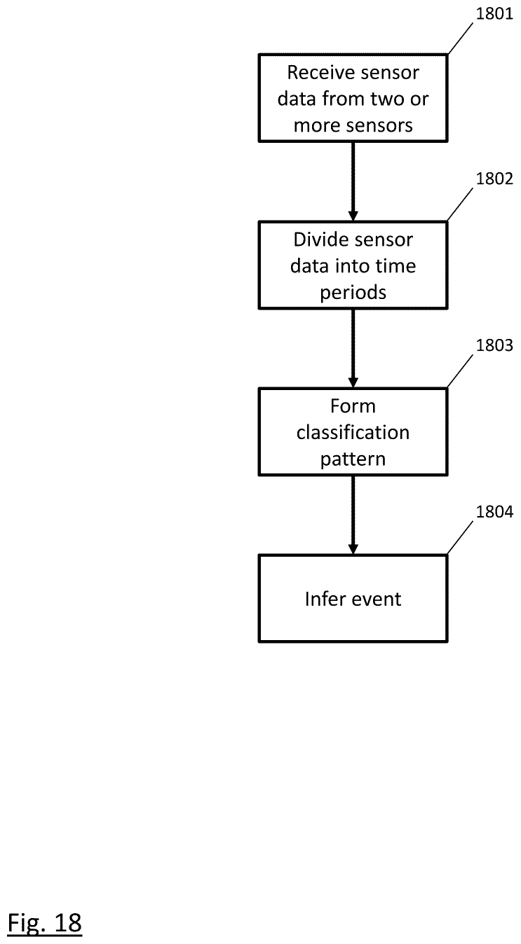

While the signal processing, inference and calibration methods described below are broadly applicable to any form of environment sensor, the present inventor has identified that they are applicable to temperature sensors. Furthermore, the present inventor has identified that identified stable regions, trend regions or rapid change regions derived from temperature sensor data are particularly informative in inferring room events of particular interest within a room for instance in a domestic premises, for instance the number of people within the room and people entering and leaving the room. Accordingly, embodiments of the present invention described below focus on the use of a single thermal sensor which is used to detect small changes in the thermal envelope associated with moving or static persons, animals, or objects as well as assessment of the overall space thermal background and any associated changes within a defined space (as shown above). It will be understood however that in its broadest form the present invention is not limited only to temperature sensors. According to an embodiment of the invention, described in relation to FIG. 18, multiple sensors are used to infer the occurrence of an event.

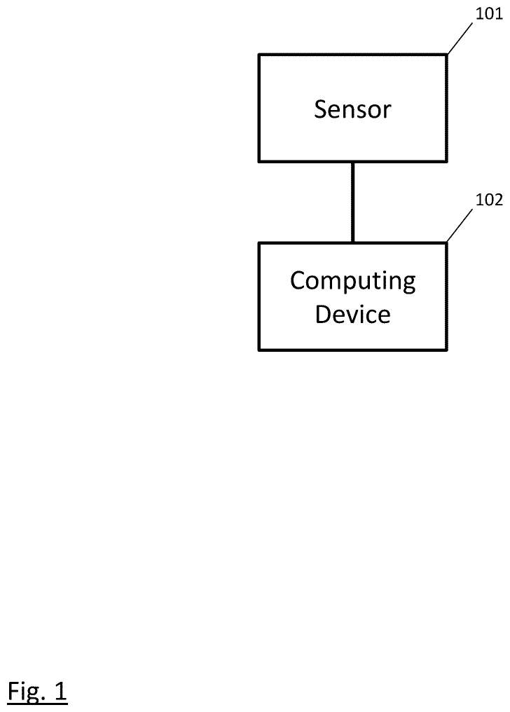

Referring now to FIG. 1, a sensing system suitable for characterising an indoor space (and for calibrating an indoor space characterisation method) according to an embodiment of the present invention is illustrated. The sensing system is shown as comprising a single sensor 101, which in certain embodiments of the present invention may be a temperature sensor. However, there may be multiple sensors as noted previously. The sensor 101 may be any suitable commercially sourced sensor available to the skilled person or a proprietary sensor providing the necessary precision described above. For instance, for the case of a temperature sensor, a sensor with a precision of ±0.1° C. (or better) may suffice to characterise an indoor space, particularly to infer events occurring within the indoor space. Improved results may be achieved with a sensor with a precision of ±0.01° C. (or better). A typical measurement frequency for sensor readings may be 0.05 Hz to 20 Hz. In some cases, the accuracy of the temperature measurement may be less significant than the precision: so long as a temperature change indicative of a room event is detectable, the magnitude of the temperature measurement may not be critical. That is, the value of the temperature reading within a temperature scale is not as important as the ability to detect changes in temperature (or indeed the absence of change in a stable region of the data). Suitable temperature sensors are widely commercially available, for instance from vendors for instance ST-Microelectronic Ltd, Analog Devices Inc, Texas Instruments Inc., and similar electronics systems providers.

The sensor data sensed by the sensor 101 is transmitted to a computing device 102, or other suitable device for processing sensor data. Where there are multiple sensors 101, each may have an associated computing device or processor 102 or a single computing device or processor 102 may process data from multiple sensors 101. The sensor 101 and the computing device 102 may be coupled together using any available wired or wireless network. The processing of the sensor data is described below starting with FIG. 4. In some embodiments the computing device 102 may be an embedded processor associated with the sensor 101. That is, the sensor 101 may be coupled directly to or incorporated into a computing device 102 as a single integrated package. The computing device 102 may perform all of the processing described below or part of the processing. It may also communicate the results to another location. In some examples, partially or fully processed sensor data (or raw sensor data) may be communicated from a computing device associated with a sensor to a building system controller responsible for controlling a building system based on the processed sensor data.

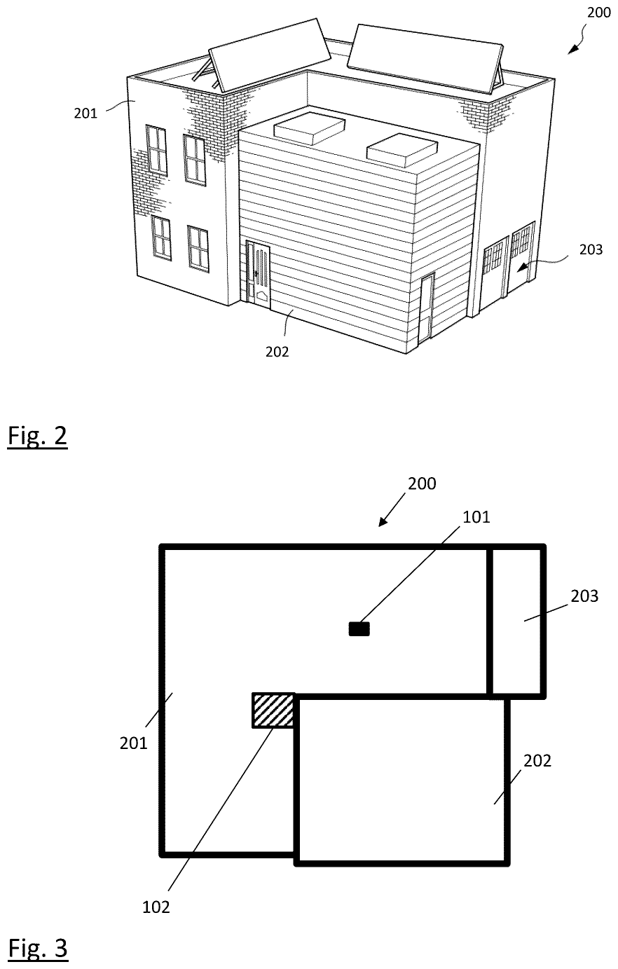

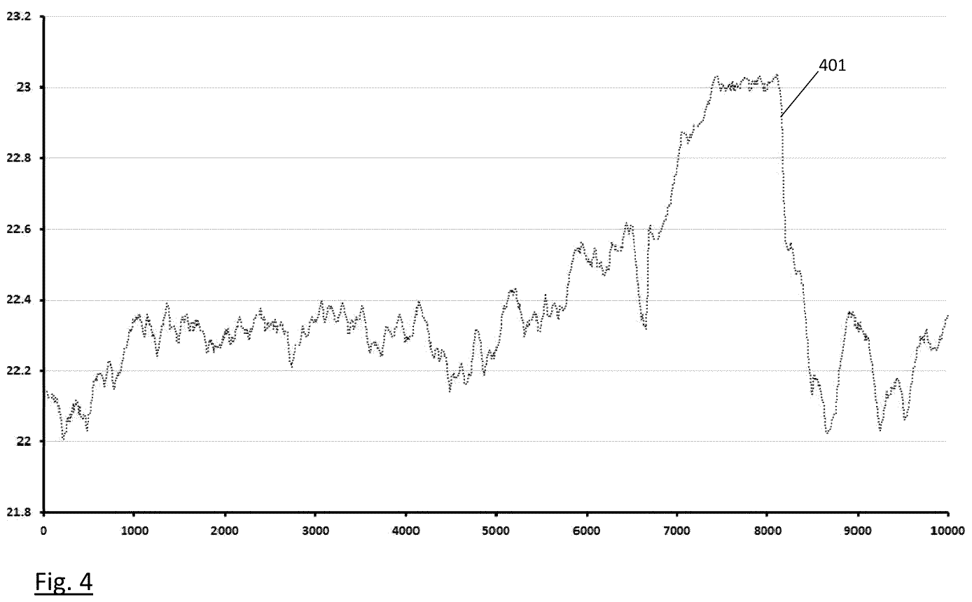

Referring now to FIGS. 2 and 3, as noted previously, while embodiments of the present invention are applicable to buildings in general, they are particularly to suited to domestic premises for instance houses and apartments (referred to generically in this document as homes). Partly this is because the daily routines of people within a home and the range of activities that take place within a home are significantly more complex than for industrial, retail, or commercial premises, with the result that it may be harder to infer indoor space states or events within the indoor space using conventional techniques. FIG. 2 is a perspective view of one particular form of home, and FIG. 3 illustrates a cross section plan view of such a home incorporating the sensing system according to FIG. 1.

FIGS. 2 and 3, show a home 200 which is constructed as a hybrid building 200 (which may also be referred to as a modular building). It should be appreciated that the specific example of a hybrid home is not limiting on the types of buildings or indoor spaces to which the present application can be applied. The hybrid building 200 comprises a first building section 201 and a second building section 202. The first building section 201 can take the form of a dock. The term “dock” is used to describe a building section to which another building section may be docked, installed, connected, or attached. The first building section 201 is an on-site construction at a final location of the building 200, which may be a fixed, on-site location. That is, the building 200 has a final, fixed, on-site location. In this exemplary embodiment, said final, fixed, on-site location is determined by construction plans and fixed by virtue of building foundations. The term “on-site location” is used to refer to the building site, which will be understood to refer to the immediate proximity of the building 200 and the entire building site, including housing estate, on which the building 200 is to be built. It will be understood that the site may be a large building/construction site comprising a plurality of plots, the final location for the building 100 being provided by one of said plots.

The second building section 202 can take the form of a module. The term “module” is used to describe a building section which can be docked, or is installable, connectable, or attachable to another building section, particularly a first building section in the form of a dock. The second building section 202 is transportable to the final location in a substantially assembled form.

During construction of the first building section 201 at the on-site location, the first building section 201 is preconfigured to receive the second building section 202. That is, the first building section 202 is constructed with the knowledge and design that a second building section is to be subsequently connected, and the first building section 201 is thus preconfigured for connection and receipt of the second building section. The second building section 202 may be removable. This could relate to the shaping of the first building section 201, through to sealing and connection features. The second building section 202 is connected to the first building section 201 at the final location of the building 200, thereby to provide said building 200 at the final, fixed, on-site location.

The first building section 201 further includes a services hub 203, which may include part or the whole of certain building systems. For instance, for a ventilation system, the services hub 203 may include ventilation system components for instance the pumping and heat exchange elements of a Mechanical Ventilation with Heat Recovery (MVHR) system.

FIG. 3 shows the sensor 101 located within dock 201, though it will be understood that this location is merely exemplary, and the sensor 101 may be in any room within any part of the home where it is desired to monitor room states and events. Similarly, the computing device 102 is shown located within dock 201, though it may be located at any convenient location so long as it can communicate with sensor 101. In some examples the computing device 102 may be collocated or integrally formed with the sensor 101. The computing device 102 may be an embedded processor. The computing device 102 may be configured to provide an output signal or a control signal, for instance a control signal for a building system (not illustrated).

Within the room or other indoor space to be characterised the sensor 101 can be positioned at any convenient location, for instance near the entrance, in the periphery, or in the middle of the room. For the selected room or other indoor space that it is desired to monitor or characterise, the selected position within the room for the sensor may affect the ability to infer room states and events and may affect the calibration process described below. In some examples a central location within a room, for instance is shown in FIG. 3, may be preferable so that the sensor readings are not unduly affected by events around the periphery which may be less significant. However, it may be located anywhere within the room, for instance it may be wall mounted. An example is that the sensor (and optionally the processor if collocated or embedded) may be incorporated into a light switch or other electrical room fitting (including ceiling mounted devices for instance light fittings) which may have the advantage of providing a power supply. It may be advantageous for the sensor to be wall mounted at approximately waist height for an average person (for example, 1.5 m off the floor). Dependent upon the type of sensor, this may render the sensor more sensitive for detecting events, for instance whether a person has entered a room. It may be advantageous to position the sensor close to the expected location of an event that it is desired to detect. For instance, if the primary interest is in inferring whether a person has entered a room, it may be desirable to locate the sensor close to a doorway into the room.

As will become clear from the discussion of calibration in the following description (particularly in relation to FIGS. 10 and 11), during calibration the relevant heat profiles from a given heat or cold source for example, can be obtained at certain distances from the sensor and this outlines the heat or cool signature of such a source to ascertain the state of the room space (that is what heat or cooling sources are present or activated). This calibration may be based on the observed state of the heat or cooling source, for instance whether it is known to be on (and optionally a heating or cooling level or setting). This may comprise correlating the observed sensor data with time periods during which a heating or cooling source is known to be operating. This correlation may comprise manually tagging sensor data, or it may be automated, for instance if a heating or cooling source is remotely controlled through a control signal that can be accessed and fed to the computing device during calibration. Calibration may comprise recording one or more thermal states of the room and the signature of the heat sources expected. Such signatures may have a similar shape but may differ in the relative magnitude. In some cases, the calibration may be performed iteratively for multiple distances between heating or cooling sources (including humans) and the sensor which can assist with ascertaining the heat or cooling source and its distance from the sensor within the relevant indoor space. It may be that certain locations within a room are particularly sensitive to detecting room states or events, as may be established through a calibration process (which may include changing the location of the sensor within a room until an optimal location is determined). For instance, for detecting when a door is opened using a temperature sensor, it may be that a location for the sensor close to the door gives the clearest indication of a door opening event in the sensor data. Alternatively, for sensing a number of persons present within a room through a temperature sensor, a location within the central region of a room may be preferred. For the case of a temperature sensor, positioning is flexible because it is the overall background temperature that is sensed. In the case sensing the presence and movement of persons is important, and then the sensor can be strategically positioned in an area closer to where people congregate or pass by. In some examples a location close to areas or movement or congregation for the building occupants may be preferable. In some examples a location close to or remote from artificial heating or cooling sources may be preferred, dependent on whether the intention is to capture information about their use or whether other events are more important to detect.

Turning now to FIG. 4, this graph illustrates raw temperature data 401 (dotted line) generated by a sensor 101 and received by a computing device 102. It may be expected that similar data can be obtained from other sensor types including fluctuations that can be used to infer the occurrence of events and indoor space states in other ways.

The X axis indicates data samples, numbered sequentially from 1 to 1140. Data samples may be received, for instance, 10 times per second. The Y axis shows temperature ranging from 22.05° C. to 23° C. It can be seen that the raw temperature sensor data 401 within this temperature range is quite noisy and includes fluctuations that may not be indicative of room states or events. However, broadly, generally steady stable regions and rapid change regions can be observed.

In certain embodiments of the present invention regions of interest within the temperature sensor may be identified within the raw temperature data. However, in accordance with other embodiments of the present invention, the raw temperature is first pre-processed.

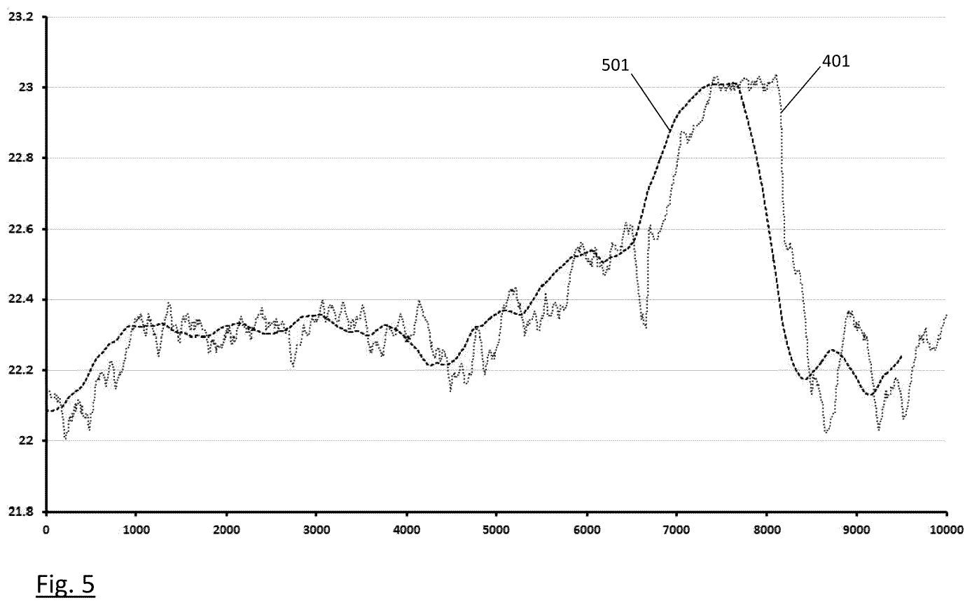

Turning now to FIG. 5, this graph shows both the raw temperature data 401 (dotted line) and filtered temperature data 501 (solid line) after a filtering process to remove any noise or irrelevant fluctuations has been applied. The filter allows for the removal of noise fluctuations and yields a trend to the data so that deduction of the heat and temperature parameters are made easier for access.

The filtering of the raw temperature data may use any conventional technique known to the skilled person that serves to remove noise and irrelevant fluctuations (but retain trend regions and rapid change regions indicative of room states and events, as well as stable regions). The present inventor has identified that for filtering temperature data a weighted window processing filter is suitable, though other filter types for instance dedicated multipole filters may be used. A further filter option would be to use a recursive filter. In other embodiments of the invention a machine learning clustering technique for clustering data points based on their similarity may be used, for instance K-means clustering. A weighted window processing filter is a type of digital signal processing filter used to modify or enhance a signal by applying a weighted average to a set of samples within a sliding window. The filter operates by first defining a window of a certain size, which may be applied to each sample in turn (with the window looking back over a preceding set of temperature samples within the window). Each sample within the window is then multiplied by a corresponding weight value, which can be predetermined or dynamically calculated based on the characteristics of the input signal. The weighted average of the samples within the window is then computed, with the resulting value replacing the original sample. The temperature data for each sample is thus replaced by a weighted average of that original sample using a predetermined number of the preceding samples resulting in a filtered output signal that is a smoothed or modified version of the original signal. Any shifts in the data can be corrected by shifting the new data by an amount equal to the width of the weighting window.

The filtering is performed by the computing device 102 and may form part of a programmed data acquisition loop whereby the temperature data is collected, and a portion is kept in memory.

The raw data stream from the sensor has m samples, as represented by equation (1) presented below, where i is an index:

$${T}_{0} , {T}_{1} , {T}_{2} , … {T}_{i} , {T}_{i + 1} , {T}_{i + 2} , … {T}_{m - 2} , {T}_{m - 1} , {T}_{m} \qquad ( 1 )$$

A weighted data stream may be established where A is a window coefficient, according to equation (2) presented below:

$${A}_{0} \cdot {T}_{0} , {A}_{1} \cdot {T}_{1} , {A}_{2} \cdot {T}_{2} , … {A}_{i} \cdot {T}_{i} , {A}_{i + 1} \cdot {T}_{i + 1} , {A}_{i + 2} \cdot {T}_{i + 2} , … {A}_{m - 2} \cdot {A}_{m - 1} \cdot {T}_{m - 1} , {A}_{m} \cdot {T}_{m} \qquad ( 2 )$$

The initial index is at a random temperature sample i which is the start of the averaging window. There are n samples or poles in the averaging window, with 0<=n<=m (the window must be smaller than the data stream). As an example: having a window size n=200 poles, then the sum calculated for the filtered sample Bᵢ₊₁₉₉ starting at index i+199 would be according to equation (3) presented below (the index varies from the start to the end of a 200 sample window):

$${B}_{i + 199} = {A}_{i + 1} + {A}_{i + 1} {T}_{i + 1} + … + {A}_{i + 199} {T}_{i + 199} \qquad ( 3 )$$

$${B}_{i + 200} = {A}_{i + 1} {T}_{i + 1} + {A}_{i + 2} {T}_{i + 2} + … + {A}_{i + 200} {T}_{i + 200}$$

$$and so on$$

The matrix for the filtered samples would be in accordance with equation (4) presented below:

$$[ {B}_{j} ] with n - 1 <= j <= m \qquad ( 4 )$$

It will be understood that there is a shift over n−1 values, along the abscissa, and this can be corrected to remove the phase delay caused. The discrepancies caused by missing out on a single sample have no significant effect.

Practically, each output from the filter is sequentially obtained from earlier data by 200 points. This may represent 10 seconds of data (200 samples when sampling at 20 Hz). This kind of time is a good representation for events that occur in real time within the living space. Such an action window may extend a few seconds to an arbitrary number (below the value m).

The raw temperature data of FIG. 4 illustrates a scenario in which a person walks into a small, previously empty room at around index 800 along the X axis. Another person joins that person a little later, with the door being opened and closed rapidly (from around index 5000) leading to a rise in temperature. A door is opened at around index 8000 one person leaves leading to a large drop in temperature, returning to approximately the temperature of just one person in the room at around index 8500. Referring to the filtered temperature data line 501 in FIG. 5, it can be seen that there are inflection points visible around these time points, following filtering using a 200 pole weighted window processing filter, whereas those inflection points are harder to identify before filtering has taken place. While a 200 pole weighted window processing filter has been applied to the data in FIG. 5, in other embodiments of the present invention a filter with 2 or more poles may be used.

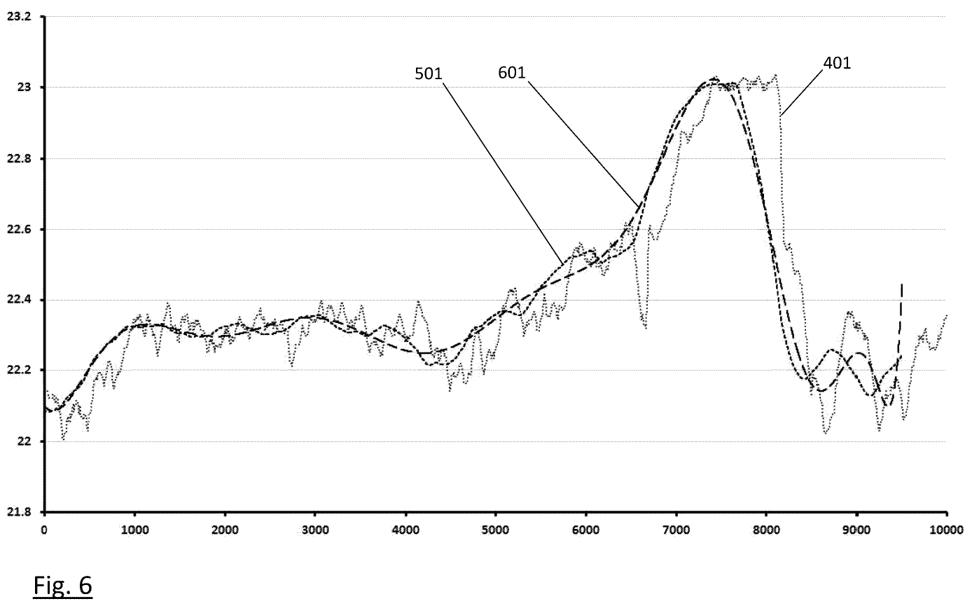

Referring now to FIG. 6, following filtering the filtered temperature data in some embodiments is further processed according to a curve fitting function. In one example, the filtered temperature data is passed to a data fitting polynomial having one or more elements. FIG. 6 shows the raw temperature data 401 (dotted line), the filtered temperature data 501 (bold dotted line) and curve fitted temperature data 601 (bold dashed line). In this step the data is outlined using a fitting curve which follows the filtered data and produces a fit which reduces the fluctuations further and highlights regions of interests. Suitable curve fitting functions will be well known to the skilled person, for instance the Chebyshev method. This curve fitting has an order equal to 2 or higher and outputs a curve fit which removes not only further residual noise but also helps show the trends in the data more consistently.

Following curve fitting there follows a third step of identifying regions of interest within the smoothed temperature data (although the skilled person will appreciate that in principle this identification step may be applied directly to the raw or filtered temperature data, though potentially with a reduction in accuracy). In this step the data output by the polynomial curve fitting function is passed through a region weighting mathematical expression which identifies the regions of remaining fluctuations and outline areas of thermal stability or regions where temperature is on varying trend. The identification of regions of interest outlines one or more of a stable region indicative of a period of time within which the received data is relatively stable within a first sensor data magnitude band; a trend region indicative of a period of time within which the received data trends upwards or downwards within a first sensor data gradient band; or a rapid change region indicative of a period of time within which the received data trends upwards or downwards within a second sensor data gradient band. The shape of this curve shows multiple “Trapezoidal” sections (that is, flat sections corresponding to stable regions and ramped sections corresponding to trend or rapid change regions).

Each stable region comprises a quasi-horizontal portion of the curve fitted temperature data 601 (or the raw or filtered temperature data) against time. That is, in a stable region the temperature remains fairly constant. By consideration of the magnitude of the temperature within the stable region (or the identification of a temperature band within which the stable region is located) an inference may be made of what heat sources are located within that room based on a prior calibration process (as is described below).

Each trend region comprises a time period including a small upward or downward trend in temperature. This can be used to infer a drift in the living space thermal envelope, but that no major event has occurred within the room. That is, it may be inferred that the room may remain within a state indicated by a preceding stable region.

Each rapid change region showing a fast change between two temperature levels and is a transient region that may be used to infer the sudden appearance of a heat gain or heat loss, based on a prior calibration process. As discussed below, in some examples a stable region or trend region followed by a rapid change region (optionally followed by a further stable region or trend region) may be used to infer the occurrence of an event, for instance a heat source (for instance a person) entering or leaving a room.

In some embodiments of the present invention potential heat and loss sources in a room are initially identified as part of the calibration process. As is described in greater detail below, these heat and loss sources are initially weighted so that each of the stable regions can be attributed to the relevant source, and rapid changes between those sources identified.

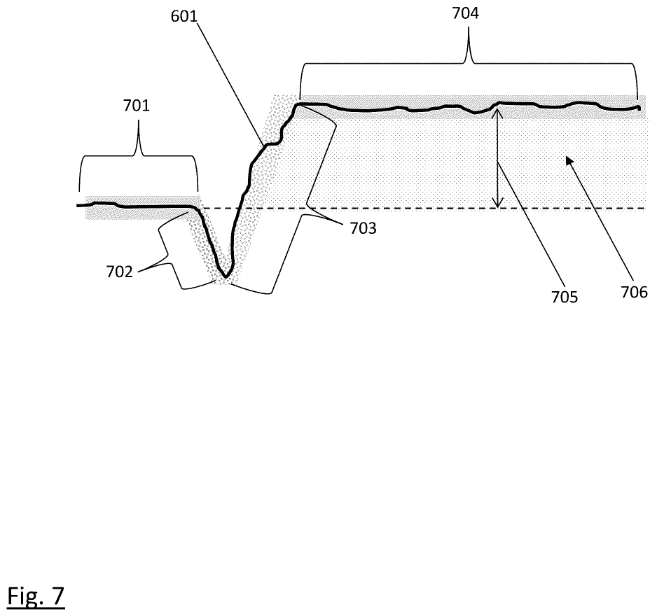

Referring now to FIG. 7, an explanation of the identification of different regions and the inference of events based on a prior calibration process is presented for the specific example of a room initially containing a single person (that is, only a single heat source), a door opening and a second person entering, and the door closing.

For a given room initially at a temperature Tₒ (which may be referred to as a baseline temperature), the entry of a single person may yield an increase in temperature in the room of ΔT₁. Assuming for the moment that the heat output from two people is similar within a broad tolerance, if N people enter the room, then the change in temperature is N·ΔT₁. It will be appreciated that different people may generate different amounts of heat, however as an approximation it remains the case that the total heat output is directly proportional to the number of people. As will be discussed below, the increase in temperature of a room per person entering the room ΔT₁ may be specific to the room (especially the size of the room, more especially the volume of the room). As such a calibration process of measuring a temperature rise as a person enters a room may be required to be performed for a specific room in which the sensor is to be deployed for detecting events including the entry of a person into a room. In some cases, an assumption may be made that ΔT₁ is the same or at least similar to within an acceptable tolerance for rooms of a similar size and for a similar sensor location. Furthermore, temperature increase ΔT₁ may be dependent on the baseline temperature T₀ and so the calibration process may require to be performed for multiple different baseline temperatures.

Similarly, a specific heat source H1 like a heater will cause a change in temperature of ΔT_{H1} (assuming for the moment that the heater is self-regulated). Again, this temperature change may be dependent upon the previous baseline temperature.

Stated generally, each heat source of loss of heat that occurs within a room may be referred to as H2 and will cause a change of temperature of −ΔT_{H2}.

The thermal profile for a given room, would therefore be subject to a series of changes outlined initially by a base temperature which can then vary according to the presence, introduction or removal or heat generating or heat removing elements, which cause a temperature change of ±ΔT_{HX}.

As an example, as illustrated in FIG. 7, the room may initially be stable at Tₒ=16° C. while empty. This first region 701 may be identified as an initial stable region on the basis that the temperature data does not vary by more than a threshold temperature magnitude throughout this region. Alternatively, the first stable region may be detected on the basis that the measured temperature remains within a temperature magnitude band during that time period. The size of the threshold temperature magnitude may be specific to a particular sensor and a particular deployment location within a room, but for instance the threshold might be ~±0.2° C. Subsequently there follows first and second rapid change regions 702, 703. A region may be identified as a rapid change region on the basis that the temperature varies by more than the threshold temperature magnitude and the temperature increases or decreases by greater than or equal to a gradient threshold through that period of time. If the gradient in a region is less than the gradient threshold, then that region is identified as a trend region. The first rapid change region 702 may be identified as a period of time between a door being opened and closed, during which time warm air escapes the room. While the door is open a person enters the room. The entry of a person may raise the temperature by circa 1.5° C. relative to the initial stable temperature in stable region 701. It may be expected that a temperature sensor will indicate an increase in temperature that stabilises after 1.5° C. has been added to the baseline of 16° C. During rapid change region 703 the room is heating up as a result of the person (that is, a heat source) entering the room. Therefore, the temperature differential of 1.5° C. can then be identified and attributed to the added presence of a person into the space. Subsequently, a second stable region 704 may be identified where the temperature is 17.5° C. and the margin that may be considered acceptable to infer that a single person has entered a room may be ±0.2° C. (that is, the threshold temperature magnitude is exceeded). That is, the temperature in the second stable region 704 may be determined according to equation (5) presented below:

$${T}_{o} + {T}_{P 1} = 17.5 \pm 0.2 ° C . \qquad ( 5 )$$

Where Tₒ is the initial room temperature in region 701 and T_{P1} is the heat output from a single person.

It will be appreciated that the temperature change yielded by a single person entering a room will be dependent on the particular volume of the room, amongst other parameters, hence the necessity of a calibration process. This may vary between for instance 0.8 to 1.5° C., and this temperature increase is indicated by the arrow 705 in FIG. 7. Furthermore, the area underneath the graph in stable region 704, relative to the baseline temperature in stable region 701, may be calculated and is indicative of the energy released into the room as a result of a single person entering (this is indicated by the shaded area under region 704 indicated by numeral 706.

FIG. 7 presents a situation in which an event comprising a person entering a room may be inferred from a sequence of events comprising an initial stable region 701, rapid change regions 702, 703 and subsequent stable change regions 704. In some cases, where the temperature outside of the room is similar to the temperature inside the room (or where a door is opened and shut rapidly) then region 702 may be absent—there may be no initial cooling as the person enters the room. It will be understood that an inference can be made that an event comprising a person entering a room has occurred from a detected sequence of regions comprising at least regions 701, 703 and 704 and consideration of the baseline temperature during region 701 and the change in temperature 705 between the stable regions. In some examples the measured temperature gradient of rapid change region 703 may be used to infer that a person has entered the room (as opposed to some other event that may give rise to a similar temperature change but more rapidly or more slowly). In some cases, a sequence indicative of a person entering a room may comprise a sequence of first trend region, rapid change region, second trend region (for instance in the case that the room is poorly insulated and heat from the room is gradually being lost) with the temperature difference between trend regions again being indicative of a person entering the room. For the case of a person leaving a room, a similar sequence of regions may be detected whereby the second stable region or trend region is at a lower temperature that the first stable region or trend region.

From the example of FIG. 7 it will be apparent to the skilled person how other types of events within a room may be inferred from a sequence of two or more identified regions in the sensor data, and optionally some parameterisation of those regions. As an example, for a first stable or trend region, followed by a rapid change region indicating an increase in temperature, followed by a second stable or trend region, if the temperature differential between the first and second stable or trend regions exceeds a threshold then it may be inferred that a heating device has been activated to warm the room, rather than a person having entered the room. It will be understood that this inference of events and discrimination of event time effectively involves looking back through recorded sensor data. The length of time that must be looked back may be variable. For instance, if a first stable or trend region followed by a rapid change region is identified then it may be necessary to wait until a second stable or trend region has been identified before the type of event can be discriminated, and this waiting period may be longer where a larger change in temperature occurs.

When the temperature is stable or within an acceptable noise margin, then a small droop (that is, a trend region) not exceeding, for instance 0.2° C. may be identified within the temperature data as a trend region. As noted previously, a trend region is one in which the temperature magnitude variation exceeds the magnitude threshold, but the gradient of that variation does not exceed the gradient threshold. In a trend region it may be inferred that there is no change in the number of people present (that is, no person related event has occurred, even though the temperature changes). In some examples after a person enters a room the initial temperature rise may be almost exponential, and detected as a rapid change region, but after a short time the temperature stabilises (identified as a new stable region) and may rise afterwards marginally (identified as a further trend region). Any change that exceeds a temperature magnitude shift above a predetermined value, or a significant temperature gradient indicative of a rapid change region may be used to infer a further room event, that is a thermal gain or loss indicative of a new event (for instance people entering or leaving the room, a door being opened or closed, a window being opened or closed etc.).

For the raw, filtered or curve fitted temperature data as set out above according to the preceding signal processing steps, for the third step of identifying stable, trend and rapid change regions the analytical method employed for windowing the values for temperature within bands covering each stable region may be set as follows.

Mathematically an arrays of values (Tₙ, timeₙ), (Tₙ₋₁, timeₙ₋₁), . . . (Tₒ, timeₒ) should outline values Ti according to equation (6) presented below:

$$∀ {T}_{i} ϵ [ {T}_{o} , {T}_{n} ] we have {T}_{i} - Δ T <= {T}_{i} < = {T}_{i} + Δ T \qquad ( 6 )$$

ΔT may be 0.2° C. for the example above. Equation (6) defines the interval for temperature bands for stable temperature regions. For all the values for T (indexed as i) belonging to the inclusive interval of temperatures from T₀ to n, the value of the i indexed temperature Ti will be within the between the values T−ΔT and T+ΔT. i takes any values from 0 to n.

ΔT is the height of the bar that defines the stable and horizontal region or interest.

A transient region (that is, a trend region or a rapid change region) is a region which stands between two stable regions or outlines a continuous significant increase or decrease in temperature.

This is outlined by events which may include opening or closing of the door, window, or the introduction of a heating or cooling source.

With respect to heating or cooling sources, these have a self-converging thermal output and may eventually lead to a stable region with respect to the heat envelope of the space considered.

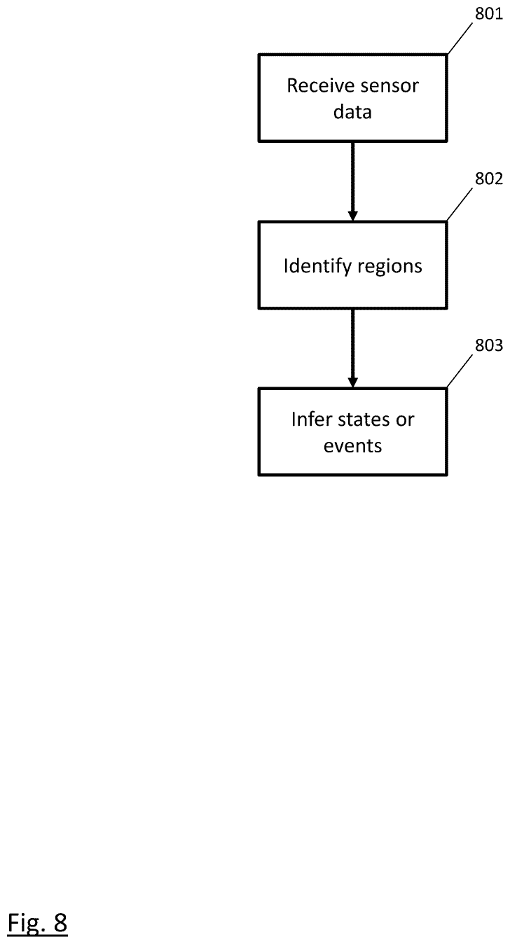

Referring now to FIG. 8, is a flowchart illustrating a method for characterising an indoor space state, particularly inferring the occurrence of an event, according to an embodiment of the present invention. At step 801 a computing device 102 receives sensor data from sensor 101.

At step 802 regions (specifically, stable, trend and rapid change regions) are identified within the sensor data according to the above described data processing techniques.

As noted above in connection with FIG. 7, the identification of regions may comprise analysing changes of sensor data magnitude and sensor data gradients in different time portions. Specifically, a stable region may be indicative of a period of time within which the received data is relatively stable. It may be identified by determining a time period during which the sensor data does not vary by more than a data magnitude threshold. In some cases, the threshold is uniform irrespective of the absolute magnitude of the sensor data. In other cases, different thresholds may apply in different portions of a sensing range of a sensor. Identification of a stable region may include identification of a data magnitude band containing the stable region data.

A trend region may be indicative of a period of time within which the received data trends upwards or downwards gradually. It may intuitively be understood as a no change region, but with some sensor drift. For the example of a temperature sensor the sensor drift may equate to gradual heat loss or warming within the room as a result of no-optimal insulation. A trend region may be identified based upon a period of time during which the sensor data varies by more than the magnitude threshold, but the gradient of sensor data change is less than a gradient threshold. Identification of a trend region may include identification of a data magnitude band containing the trend region data.

A rapid change region may be indicative of a period of time within which there is a significant change in the sensor data indicative of an event which has occurred within the room. A rapid change region may be identified based upon a period of time during which the sensor data varies by more than the magnitude threshold and for which the gradient of the sensor data gradient is greater than or equal to the gradient threshold. It will be appreciated that like the threshold temperature magnitude, the threshold temperature gradient may be context specific. However, in some examples the gradient threshold which if exceeded indicates a rapid change region may be ~0.05° C./s (degrees Celsius per second). A trend region may have a markedly lower gradient, for instance ~0.01° C./s or lower, which may normally be experienced for a longer time period, for instance in excess of 3 s. Accordingly, the length of a change in temperature data may also be indicative of the type of change. Identification of a rapid change region may include identification of a data gradient band containing the rapid change region data.

At step 803 an inference is drawn regarding what each identified region (or groups of regions) relates to. This inference is based on a prior calibration process for that sensor, that room and typical room states and events that may occur in that room.

For an identified stable region or a trend region, a room state may be identified by looking at the average sensor data during the stable region and using a look-up table showing sensor data magnitude bands and corresponding room states for each band. The room states may comprise, for instance, the number of occupants and whether artificial heating or cooling appliances are operational. The number of room states and their corresponding sensor data bands will be specific to the particular installation. In some cases, the duration of a stable region may also be used as part of the inference of a room state.

For an identified rapid change region, the average gradient during that region may be compared to a look-up table showing sensor data gradient bands and corresponding room events for each band. The events may include, for instance, a person entering a room, a person leaving a room or the operation or discontinuance of an artificial heating or cooling system. In some cases, the duration of a rapid change region may also be used as part of the inference of a room event.

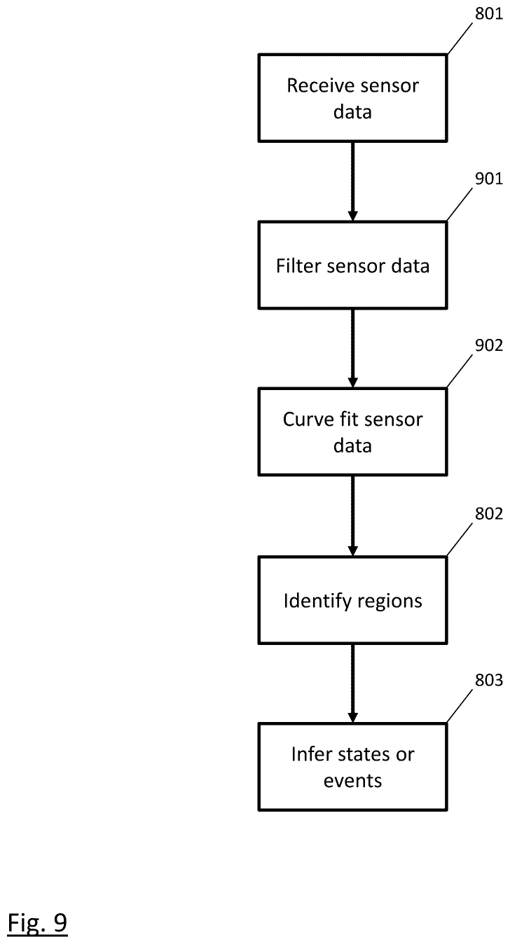

FIG. 9 is a flowchart illustrating a method for characterising an indoor space state according to a further embodiment of the present invention. Steps 801, 802 and 803 are as described above for FIG. 8. Step 901 of filtering the sensor data corresponds to the filtering process described above in connection with FIG. 5 for reducing noise and fluctuations not indicative of room states or events. Step 902 of curve fitting the sensor data corresponds to the curve fitting process described above in connection with FIG. 6 for further smoothing the data before regions are identified.

The above-described method for identifying data regions and inferring room states and events has been proven by the present inventor to be particularly appropriate and robust. Nevertheless, the skilled person will be aware that alternative data processing techniques may be applied, for instance the use of a trained machine learning algorithm to process sensor data and infer room states and events (again based on a prior calibration process to form a suitable training data set).

According to an embodiment of the present invention, the inference of a room event may take account of two or more concatenated or sequenced regions. The concatenated regions may, for instance, comprise at least one stable or trend region and at least one rapid change region. Or they may comprise two or more concatenated rapid change regions (or any combination). As one example, a sharp drop in temperature sensor data followed by a rapid rise may indicate that a door has been opened, a person has entered, and the door has been closed behind them. Alternatively, an increase in temperature following a stable region may indicate that an artificial heating system has been turned on. As discussed previously in connection with FIG. 7, a sequence comprising a first stable or trend region, a rapid change region (increasing temperature) and a second stable or trend region, may be used to infer at step 803 that a person has entered the room. In some cases, the inference that a person has entered the room is further dependent on a baseline temperature during the first stable or trend region and a temperature difference between the first and second stable or trend regions. In some cases, the inference that a person has entered the room is further dependent on the gradient of the rapid change region. Further examples of information that can be discerned from a sequence of regions and used to discriminate between different types of events will be apparent to the skilled person.

While the particular example of a temperature sensor has been given above, the sensor may be any suitable type of environmental sensor, for instance, temperature, pressure, humidity, gas (for instance CO₂), a particulate matter sensor, a background pressure and differential pressure sensor, a proximity or motion sensor, a light sensor, or a distance or range sensor. The present inventor has however identified that temperature sensors yield particularly useful information for inferring room states and events for instance doors opening and people entering and leaving. Advantageously, this information, obtained from a low cost, may have clear applications for controlling building systems for instance HVAC and security systems, as will be apparent to the skilled person, and as is described in greater detail in the description below. Nevertheless, a calibration process as will be described below may allow similar determinations to be made of room states and events for different sensor types.

Where a temperature sensor is use, an inferred room state may comprise a state in which the number of heat sources and heat sinks within the indoor state remains static. Similarly, an inferred event that has occurred within the room may comprise one of: a heat source entering or being activated in the indoor space; or a loss of heat being triggered in the room. A heat source entering or being activated in the indoor space may comprise: an artificial heating system being activated within the indoor space; or a person or animal entering the indoor space. A loss of heat being triggered in the room may comprises: an artificial cooling system being activated in the indoor space; an artificial heating system being deactivated within the indoor space; an aperture, for instance a door or window, being opened allowing warm air to vent from the indoor space; or a person or animal leaving the indoor space.

When a room state or event is inferred then this information may be output or used in any suitable form. For instance, it may be displayed on a screen or communicated to any required recipient or device. In some cases, the information may directly feedback to a building system that is being controlled, as is described in greater detail below.

Turning now to FIG. 10, this is a flowchart illustrating a method for calibrating a system for characterising an indoor space state according to an embodiment of the present invention. Essentially the calibration process comprises the receipt of sensor data 1001 while also observing 1002 indoor space states and events that occur in the room and correlating 1003 these to the sensor data. By observing indoor space states and events, it is meant that the sensor data is collected during known space states and during known events in the indoor space. The system may receive some form of input identifying that the room is in a certain state or that a certain event has occurred. This could be a manual input, or it may be automated, for instance though use of a separate sensor type (for instance a motion detector to detect an event of a person entering or leaving a room during calibration). This may, for instance, comprise a process of manually tagging sensor data with time periods during which an event is known to have taken place. As an example, a person may enter a room while sensor data for instance temperature data is being collected in that room, and the sensor data while the person enters the room (and for a certain period prior to the entry and following the entry) recorded as such. Accordingly, a set of data may be built up comprising multiple instances of sensor data correlated to observed or known events that have taken place. In particular, the calibration may for instance comprise the collection of sensor data during periods of time where the number of occupants of a room remains static. Also, for the case of a temperature drop sensed when a door opens, a door may be repeatedly opened and closed and a body of sensor data during open periods be recorded.

Typically, a calibration may need to be repeated for each room or if a sensor location within the room changes. However, in some cases, where two rooms are similar in terms of their layout and fixed heat sources and sinks then an assumption may be made that the calibration performed for one room may apply equally to the other room. This may be the case particularly for new build housing where on a new housing estate there may be multiple instances of houses with the same floor plan, only one of which need be calibrated.

Referring to FIG. 11, this expands upon the correlation step 1003. For a body of sensor data relating to known time periods when a room is in a static state, sensor data magnitudes may be measured at step 1100 and at step 1101 a series of data magnitude bands for observed room states may be established. Thus, when in operation, for an identified stable region (or trend region) the sensor data may later be compared to the bands to infer a current room state. The calibration process may in some examples comprise taking initial measurement of given cooling or heat sources and recording such values at typical distances from the sensor, including one distance or more. The values recorded will allow for not only asserting the source of heating or cooling but potentially the distance from such a source. As an example: a fixed heater appliance will provide a temperature profile that is repeatable because it is fixed. Should it be moved then that the changed temperature profile may be indicative of the distance between the sensor and the heater.

For room events sensor data gradients may be measured at step 1102 during each observed event. At step 1103 a series of gradient bands may established corresponding to the observed events. Thus, the sensor data may later be compared to the bands to infer a current room event.

It will be appreciated that the number of room states and room events, and thus the number of bands and their divisions will be context dependent.

According to certain embodiments of the invention whereby an event is inferred from a detected sequence of two or more sensor data regions, steps 1002, 1102 and 1103 may comprise identifying a sequence of two or more regions during a time period in which a known or observed event has taken place (and parameterising those identified regions). Accordingly, if the same sequence of regions is later observed, then it can be inferred that the same event has occurred.

Taking the example of an event comprising a person entering a room, for the example of a temperature sensor, the calibration process may comprise: recording a temperature magnitude or temperature magnitude band for a first stable or trend region immediately prior to a person entering the room, noting the rapid change region as the person enters and immediately afterwards (and optionally recording the temperature gradient or gradient band during the rapid change region) and recording a temperature magnitude or temperature magnitude band for a second stable or trend region immediately after the rapid change region. The temperature differential between the first and second stable or trend regions may also be recorded. Accordingly, if a sequence of stable/trend region, rapid change region, stable/trend region is subsequently detected, and the temperature differential is the same as that determined during calibration (or within a range of tolerance) then it may be determined that a person has entered the room.

The calibration process may be repeated during multiple instances of the same observed or known event and the data parameterising the detected sequence of regions (for instance temperature magnitudes and gradients) may be averaged and/or used to determine bands such that if the later recorded regions are not identical to those recorded during calibration, then an event may still be correctly inferred.

Furthermore, as discussed previously, for the example of an event comprising a person entering a room, a temperature differential between first and second stable/trend regions may be different according to the baseline temperature (that is, the temperature during the first stable/trend region). Accordingly, the calibration process for a person entering a room may comprise repeating the event of a person entering the room for multiple different baseline temperatures. Accordingly, a set of calibration data for each event type may be built up. This may be used in a look-up table for inferring whether the same event has later taken place. For the example of a person entering a room, the process of step 803 of FIGS. 8 and 9 may thus comprise identifying a sequence of a first stable/trend region, a rapid change region (temperature increase), and a second stable/trend region. Next, the temperature or temperature band for the first stable/trend region may be noted and used to look-up in the look-up table the expected temperature differential (or temperature differential range) between first and second stable/trend regions indicative of a person entering the room. If the measured temperature differential matches the expected differential, then it may be inferred that a person has entered the room. Else, the look-up table may be further interrogated to identify alternative types of events that may be matched to the detected sequence of regions.

A calibration process according to an embodiment of the present invention will now be described in greater detail. The particular example given is for calibrating a small living space of approximately 4 m long by 3 m wide and 2.5 m tall (typical for a room in a home in the UK). The calibration process may be performed for the living space all fixtures present (for instance, heaters, coolers, windows, door, etc.) and any other related items.

The sensor (or where applicable, multiple sensors) is placed at a convenient location within the room. With all exits closed, the sensor is started in order to collect sensor data within the empty room. This provides a primary baseline temperature (Tb1). In some cases, the temperature in the corridor and outside are also noted.

The living space or room is annotated with its start temperature Tb1. This exercise can be repeated recursively for two or more baseline temperatures, Tb1, Tb2, etc.

After a short time, a person enters the room from the corridor (briefly opening and closing the door). The sensor data shows a sudden increase in temperature and then stabilises at a higher temperature level. This yields the temperature change for one person getting into and remaining in the space. This temperature can be referenced as Tp1 and stored for reference.

This process may then be repeated for further events, for instance a second or third person entering the room, giving a temperature differential Tp2 (two persons in the space). Tp3 (for three), etc. Again, this may be repeated for each event with different baseline temperatures. Furthermore, the process may be repeated for other types of events, for instance a heater being switched on in a vacant room, which may be expected to yield a temperature change of Th1 (which may be larger that Tp1. This may be repeated for an occupied room. Further events may include a window being opened (and left open) leading to temperature change Tw1, a door being opened (and left open) leading to temperature change Td1, etc.

This accumulated information may be used to populate a look-up table, such as is shown in Table 1, below. The look-up table may be extended with further information about each event, such as temperature gradient or duration information for the rapid change region. Other suitable parameters will be apparent to the skilled person. As previously noted, for each baseline temperature and event, the experiment may be repeated to provide an average figure or a band of figures to avoid anomalies skewing the table.

TABLE 1

| | Corresponding temperature change | | |
|---|---|---|---|
| | Baseline | Baseline | Baseline |
| | temperature | temperature | temperature |
| Event | 1 | 2 | 3 |
| 1^{st} person enters the room | Tp11 | Tp21 | Tp31 |
| 2^{nd} person enters the room | Tp12 | Tp22 | Tp32 |
| 3^{rd} person etc. | Tp13 | Tp23 | Tp33 |
| Heater switched on in | Th11 | Th21 | Th31 |
| vacant room | | | |
| Window opened | Tw11 | Tw21 | Tw31 |
| Door opened | Td11 | Td21 | Td31 |
| . . . | | | |

The three baseline temperatures may, for instance be 12° C., 17° C., and 22° C. (there may be further temperatures, and these may be selected for those typical for that room). The look-up table may be recursively formed. During operational use of the sensor to infer events, the look-up table may be used by cross referencing for instance a baseline temperature and a temperature differential resulting from a rapid change region. For sensor values falling between data in the look-up table (for instance, a baseline temperature that is not recorded in the table) a process of interpolation may be applied to determine temperature change data for that baseline.

In some embodiments of the invention, the look-up table may be formed in a prior calibration process before the sensor is operationally used to infer events (or a previously formed look-up table may be imported, for instance one created for a similar room. In some embodiments of the invention, the look-up table may be extended during operational use, for instance if a recorded baseline temperature and temperature change are not matched exactly to the table, but through interpolation the type of event can be discriminated, that data may be added to the table. The addition to the table may comprise the stored data and the measured value being averaged together and the resulting value replacing the one in the look-up table. In some examples the look-up table may comprise baseline temperature bands and bands of temperature change matched to different events. Those bands may be adjusted during operational use of the sensor to account for real life use of the room by adaptation of the look-up table over time.

During operational use, the event inference is carried out through comparison of the temperature change caused by such event to temperature values saved in the processor memory as a look-up table. The increase in temperature due to a specific event from a baseline value is therefore compared to entries in the look-up table and the extent of the change for such a baseline identified with a corresponding event in the look-up table.

When the event occurs from a state where the living space is in its initial state (unoccupied), the temperature baseline for such a space is also available in the look-up table. Two values or more are stored in the look-up table and are used as references to outline the thermal state of the unoccupied space under different temperatures.

The increase in temperature which is due to a given event has a rate of change (a hotter source can yield a faster rise in temperature, for example) and in certain embodiments this is used to further discriminate between events using the rate of change caused. However, identifying the temperature change is closely related the temperature rate of change for a given event. This is because the rate of change is identified by the time it takes to reach the temperature related to the inferred event. The time periods between temperature measurements may be used to obtain a time stamp between the start of the rise and start of the temperature stabilisation for the event.

Comparing the time stamp magnitude with the temperature for the event yields a rate of change for the event.

Furthermore, by adding together the values for temperature from the start of the given baseline to the point where the temperature changes start to stabilise (value for the temperature change caused by the event), a value proportional to heat imparted by the event is obtained. This is shown in FIG. 17 using the shaded (quasi-triangular) area delimited by points A, B, and C, where A is the start of the change in temperature, B is the threshold value reached for the event, and C limits the extent of shaded area for a representative rate of change. The shaded area represents the initial packet of energy radiated by the event prior to the room stabilising after. This method enables further discrimination of events caused by sources with different heat capacities.

The assessment of the level change for the calibration method relies on the summation of the measured temperatures which are within the area delimited by the point where the change is initiated and the point where a new stable level is achieved (quasi-triangular are A: B: C in FIG. 17). Both are referenced to the time axis which represents the abscissas.

For instance, if we introduce a given finite heat source into the living space, and assume that the change in temperature starts at time tᵢ (taken as an arbitrary time reference at data index i) from a temperature level Ti, then after a time t_{i+Δt} the temperature stabilises at a new temperature level T_{i+Δt}.

Therefore, the quasi-rectangular triangle where the hypotenuse is the length of the change segment can be considered. The analytical expression for the (proportional) energy imparted and caused by the change in temperature can henceforth be expressed at the summation of the temperatures within such square triangle. This yields the energy E (tᵢ, t_{i+Δt}) imparted for such a change, and is solely dependent on the source responsible for such a change. This can be expressed according to equation (7) presented below:

$$E ( {t}_{i} , {t}_{i} + Δ t ) = {\sum }_{t = ti}^{t = ti} {}^{Δ t} {T}_{t} \qquad ( 7 )$$

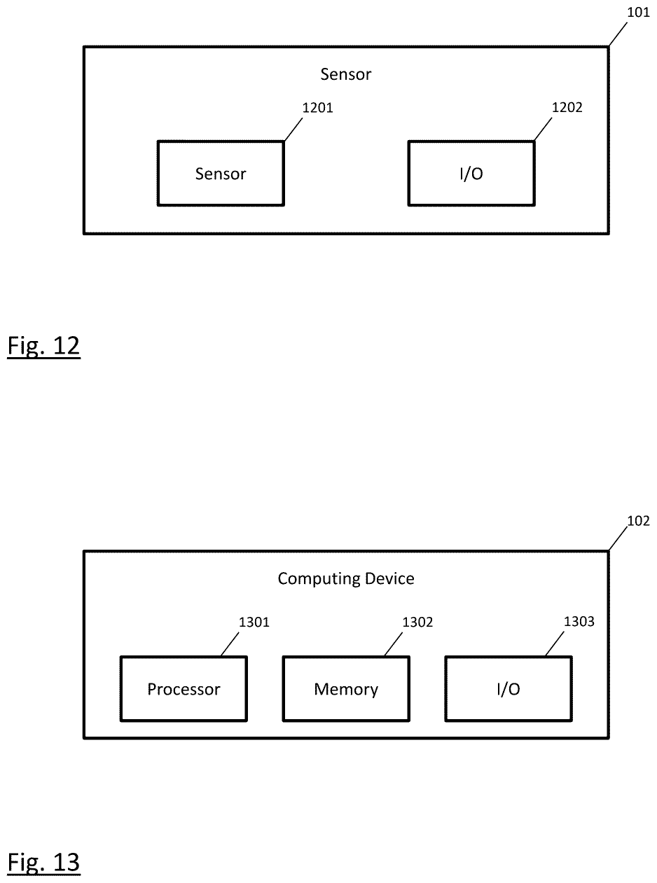

FIG. 12 illustrates a sensor 101 configured to communicate sensor data to a computing device according to an embodiment of the present invention. For instance, the sensor 101 may form part of the sensing system of FIG. 1, communicating with the computing device 102. The sensor 101 may comprise a sensor 1201 capable of generating sensor data indicative of at least one sensed parameter and some form of input/output device 1202 configured to communicate that sensor data to other a computing device across a network. The network may be a wired or wireless network within a home. As noted above, the sensor 101 and the computing device 102 may be integrated into a single package or device. The sensed parameter may be an environmental parameter, for instance temperature, pressure, humidity, gas (for instance, CO₂), particulate matter, background pressure and differential pressure, proximity or motion, light, or distance or range. It will be appreciated that in other embodiments the sensor device 101 may include further components, for instance memory configured to buffer sensor data for periodic transmission and a processor to control the other parts.

FIG. 13 illustrates a computing device 102 configured to receive and process sensor data to a computing device according to an embodiment of the present invention. The computing device 102 comprises a processor 1301, memory 1302 and some form of input/output device 1303 configured to communicate with the sensor 101 across a network. The memory 1302 stores executable instructions that, in response to execution by the processor 1301, cause the computing device 102 to perform the indoor space characterisation method of FIGS. 8 and 9 or the calibration method of FIGS. 10 and 11.

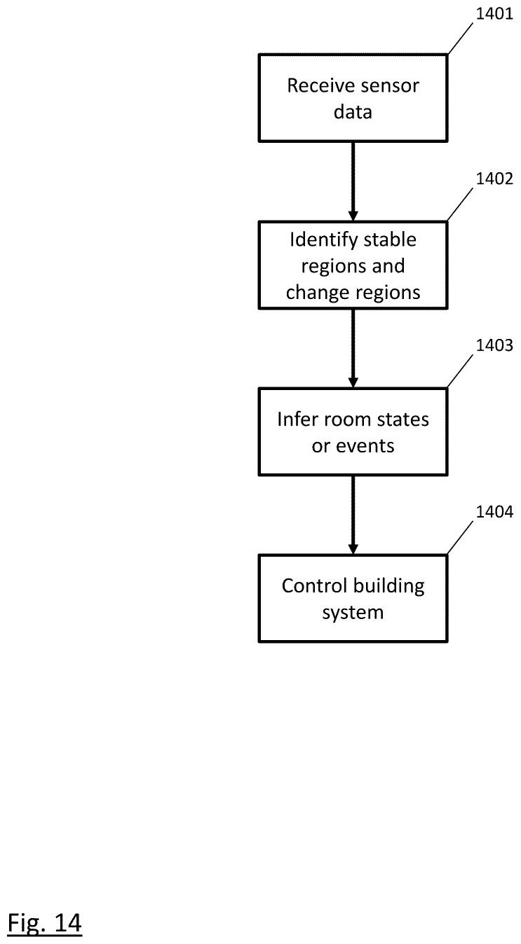

Referring now to FIG. 14, this is a flowchart illustrating a method of controlling a building system using a sensor. At step 1401 a sensor 101 senses an environmental parameter and passes data indicative of the environmental parameter to a computing device 102. The sensor 101 and the computing device 102 may be collocated or the data may be transmitted across a network. The computing device 102 may be incorporated into a building system controller configured to control components of a building system. In some examples, part of the processing may be performed at a computing device collocated with the sensor and part may be performed at a remotely located building system controller. The skilled person will understand that numerous permutations are possible concerning the distribution of computing resources and processes, and that the computing topology is less significant than the processing performed on the sensed environmental parameter.

At step 1402 the sensor data is processed to identify stable regions and change regions. The term “change regions” is intended to encompass trend regions and rapid change regions as described above. At step 1403 the identified data regions are interpreted to infer room states or events. The processing of steps 1402 and 1403 may be substantially as described above, particularly in connection with FIGS. 8 and 9. Furthermore, this processing may be based on a prior calibration process performed for a particular sensor 101 disposed in particular room (for instance as illustrated in FIG. 3). The calibration process may be as described above in connection with FIGS. 10 and 11.

At step 1404 the inferred room states or events are used to control a building system. The nature of the building system and the nature of the control should be interpreted broadly, and the following examples should not be considered limiting.

The building system may comprise any form of building system found within a building for instance a home. As non-limiting examples the building system may be one or more of a building ventilation system; a building heating system; a building air conditioning system; a building security system; a building lighting system; or a building mechanical control system. A building mechanical control system may include actuators for opening, closing, or adjusting any moveable part of a building, or instance windows, doors, curtains, blinds, or room dividers. In particular, the building system may suitably be any building system where it is desirable to be able to take account of detected room states or events as described above. As an example, it is desirable to be able to take account of the number of people present within a room or whether doors or windows are open or closed when controlling a heating system.

Controlling a building system based upon the inferred room state or event may comprise controlling any controllable component of a building system on a per room or per building basis. For instance, for the example building systems set out above, any of the following system components could be controllable (and other examples will be readily apparent to the skilled person): a ventilation fan, a ventilation valve, a heating control, heating output device or valve, an air conditioning control, output device or valve, a light, or a security alarm, security light or security output signal to a remote device or monitoring service.

It will be appreciated that a building system, for instance a heating system, conventionally incorporates a building system controller for controlling the various components of the system. In certain examples of the present invention the building system controller may be modified to perform some, or all of the above-described processing of steps 1401 to 1403 based on received sensor data or partially processed sensor data. In other examples, the building system controller may be substantially conventional other than being configured to receive a control signal from a separate computing device that is configured to infer room states or events and generate a control signal.

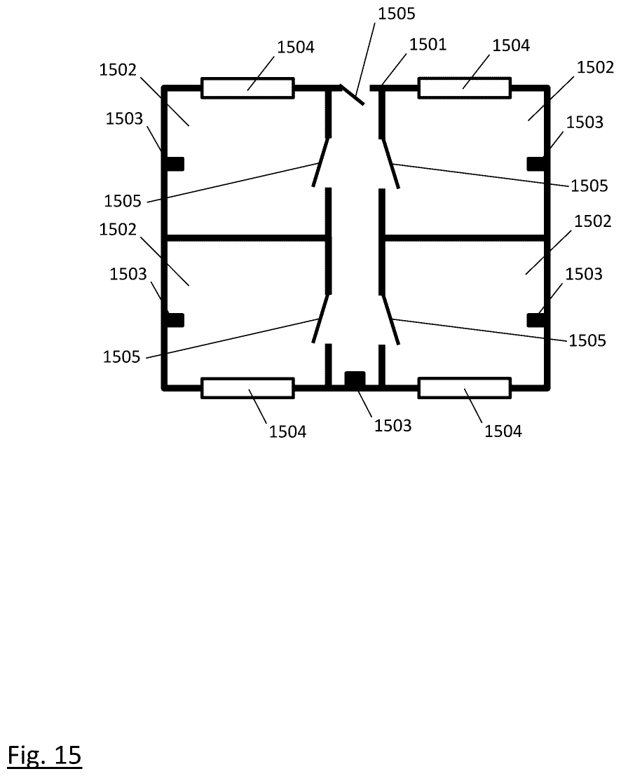

In some cases, the sensor may be located within a single room and the building system is controlled in respect of the whole house based upon sensor data for that room. As an example, the sensor may be positioned in a central position within the home and configured to infer room states and events that may be indicative of activity throughout the home such that the building system may be controlled throughout the home. In other examples, as described below in connection with FIG. 15, sensors may be located in a plurality of rooms within a building allowing the building system to be controlled differently for each room.

The control of a building system according to step 1404 may comprise generating an output signal indicative of a building system state. This output signal may be communicated in any form. For instance, it may comprise the building system state being communicated to a separate control system which is configured to independently determine how a building system should be controlled (based optionally on further sensed or determined factors). In some cases, the output signal may be communicated to a building occupant, for instance by being displayed on a control panel or through an app on a mobile device. The building occupant may thus be empowered to manually control a building system. As an example, the control output may indicate that the detected number of people within a building or a room within the building has increased, permitting the user to determine for themselves whether to reduce a heating system output.

Alternatively, or additionally, the control of a building system according to step 1404 may comprise generating a control signal to control at least one component within a building system. As an example, the control signal may control a component of a heating system (for instance a boiler or a thermostatic radiator valve) to turn on or adjust a temperature set point. More generally, the control signal may instruct at least one component of a building system: to turn on or off; to adjust a set parameter; to change a mode of operation or to perform any other appropriate action based on the nature of the building system and the nature of the detected room state or event within the room.

As for the previous section of the present document concerning the identification of room events and room states, the sensor is not limited to any specific type. Following a suitable calibration process, substantially any measurable environmental parameter may yield information from which room states and events can be inferred. This includes a temperature sensor, a pressure sensor, a particulate matter sensor, a humidity sensor, a gas sensor (for instance CO₂), a background pressure and differential pressure sensor, a proximity or motion sensor, a light sensor, or a distance or range sensor. However, the present inventor has identified that a temperature sensor is particularly suited to determining room states for instance the number of occupants, whether heating or cooling devices are active or whether doors or windows are open and determining room events for instance a change in the number of occupants. These inferred room states and events are self-evidently pertinent to the control of a building system and temperature sensors may be readily and cheaply implemented within a building.

As explained in detail in the above description, a temperature sensor may be used to infer a room space state comprising a state in which the number of heat sources and heat sinks within the room remains static. Similarly, an inferred event that has occurred within the room may comprise one of: a heat source entering or being activated in the room; or a loss of heat being triggered in the room. A heat source entering or being activated in the room may comprise: an artificial heating system being activated within the room; or a person or animal entering the room. A loss of heat being triggered in the room may comprise: an artificial cooling system being activated in the room; an artificial heating system being deactivated within the room; an aperture, for instance a door or window, being opened allowing warm air to vent from the room; or a person or animal leaving the room. The above-described room characterisation method is able to differentiate between different room events based on parameters including the gradient of a change in temperature and a pattern of consecutive identified stable regions, trend regions and rapid change regions.

It is particularly important when controlling some building systems to be able to determine the number of occupants within a building or within a room or group of interconnected rooms within a building. It will be apparent to the skilled person that using a temperature sensor to infer room states and events it becomes possible to essentially count people entering or leaving a room and so keep a tally on the number of occupants. The determined number of occupants may be a key control input for a building system. For instance, for a heating system this may be used to control the amount of artificial heating required within a room or a building to maintain a desired temperature, by taking account of the thermal output of each person within the room. For a lighting system, where it is determined that the last occupant has left a room, section of a building or whole building then the lighting can be controlled accordingly, for instance by switching it off. For a security system, if a person is detected within a room at a time of day when people are not expected or previously programmed to not be permitted then this may trigger a security alarm. Other ways of using occupancy information to control building systems will be apparent to the skilled person.

Where the environment sensor is a temperature sensor, in addition to using sensor data to infer room states and events (based on changes in temperature) the temperature magnitude may also be used as a control input for a building system. As an example, for controlling a building heating system, the current ambient temperature is typically a required control parameter. This removes the need for an independent temperature sensor or thermostat for controlling the heating system.

Embodiments of the present invention concerning measuring room or building occupancy may be referred to as “quasi real-time occupancy”. This is because using a temperature sensor to detect building occupancy effectively looks back in time to recent changes (within the last few 10 s of seconds or a few minutes) as it is dependent on measuring a change in temperature of a series of sensor readings. This contrasts with conventional approaches to measuring occupancy, for instance using cameras or motion sensors, which are real-time, or near to real-time. Nevertheless, dependent on the building system being controlled, this may be immaterial. For instance, for a heating system, the response time from a control input to a measurable change in room temperature may be of the order of several minutes. Therefore, quasi real-time occupancy information is sufficiently rapid to be suitable for use as a control input. Furthermore, compared to using cameras to detect occupancy, using a temperature sensor to detect occupancy has numerous advantages:

temperature sensors are much lower cost and so may be more widely deployed through a building (discussed below in connection with FIG. 15). Temperature sensors are lower power and less computationally expensive to process the generated data than for camera systems. As a consequence, and as noted above, this means that the processing for the sensor data may be performed by a low cost, local (embedded) processor. A further advantage relative to the use of cameras is that there is no privacy issue as no personally identifiable data is generated. This latter point is particularly relevant for public buildings, for instance, offices and hospitals.

Where occupancy is inferred from sensor data, occupancy patterns over time may be established. This occupancy information may be used to predict future occupancy patterns, and predicted future occupancy may itself be used as a control input, for instance to turn on a building heating system in advance of a time of day or day of the week when it is normally expected that the building will be occupied. This may be relatively simplistic, for instance establishing times and days when based on historical occupancy data it is more probable than not that the building will be occupied. In some examples of the present invention historical occupancy information built up over a period of weeks or months may be processed using a machine learning algorithm to make predictions of future occupancy. The output predictions may be validated using subsequent live occupancy information, which may be used to improve the algorithm.

Turning now to FIG. 15, this illustrates a plan view of a home 1501 in which a sensing system according to an embodiment of the present invention is deployed with a sensor in each room 1502. Specifically, FIG. 15 illustrates a building, particularly a home 1501, having four rooms 1502, each room 1502 having a sensor 1503. Sensor 1503 may correspond to sensor 101 described above. It may include an embedded computing device 102 performing some or all of the processing to infer room states and events or this may be performed by one or more remotely located computing devices (not illustrated). Inferred rooms states and events (wheresoever processed) may be communicated to a building system controller (not illustrated) for controlling a building system (not illustrated). Each room 1502 opens onto a corridor 1506 through a door 1505. Corridor 1506 may also include a sensor 1503. Each room 1502 further has a window 1504 which opens to outside of the building 1501.

In accordance with embodiments of the present invention the sensor 1503 in each room 1502 is configured to determine room states and events specifically for that room. This may include independently determining the number of occupants of each room 1502 and whether doors 1505 and windows 1504 are open. Advantageously, this allows a building system to be controlled on a per room basis. As an example, for a building heating system with a radiator or other heating appliance located in each room, each radiator may be controlled to provide an appropriate ambient temperature for each room according to the number of occupants (which may include turning off the heating in that room if the room is determined to be empty). Similarly, ventilation, cooling, lighting, and security systems can be controlled on a per room basis according to occupancy information.

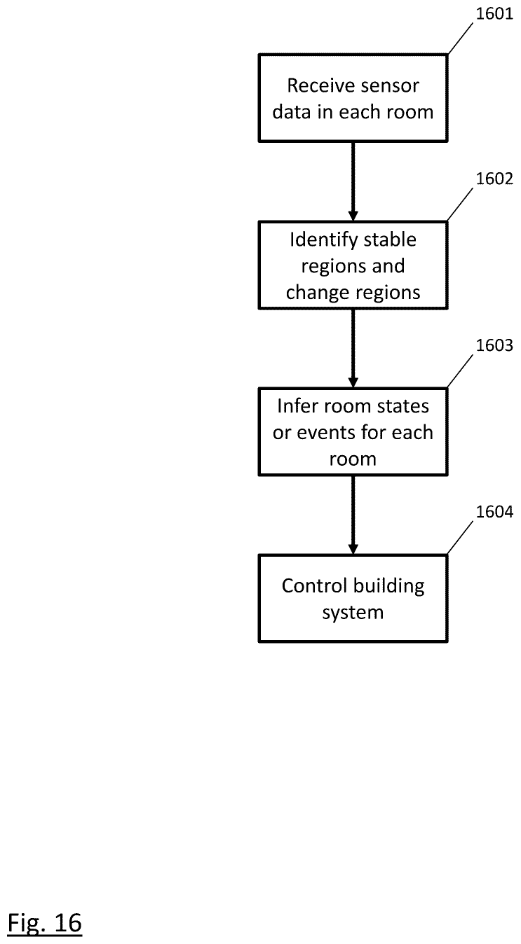

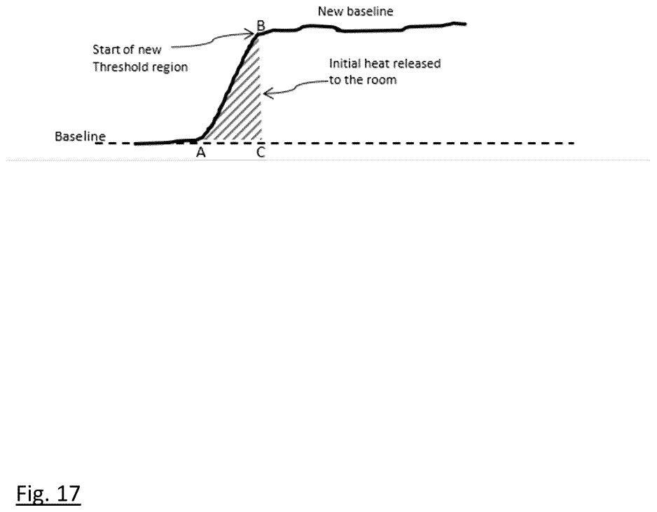

FIG. 16 is a flowchart illustrating a method of controlling a building system using multiple sensors as deployed in separate rooms. At step 1602 for each sensor in each room sensor data is received (for instance at an embedded processor) and at step 1602 the sensor data is analysed to determined data regions. At step 1603 room states and events may be inferred individually for each room. At step 1604 this information is used to control a building system separately for each room. This building system control may be centralised. That is, the room states and events for each room may be processed or received at a central location—a building system controller—and used to control building system components separately for each room. Alternatively, some or all of the processing may be performed separately for each room. For instance, a processor embedded with a sensor 1503 in a given room may infer room state or event information and directly use that inferred information to control a building system component for instance a heating appliance in that room without recourse to a central building system controller.

It will be understood that where a room is equipped with a sensor 1503 then occupancy information may be determined in respect of that specific room based upon the inferred room states or events. The building system may therefore be controlled based upon the determined occupancy information for each room. This may be controlling the building system separately for each room based on the determined occupancy for that room, or controlling the building system for the entire building according to the aggregate occupancy information (or a combination of both).

As discussed above, embodiments of the present invention are able to infer events occurring within a room including whether a door or window is open or opened. According to a further embodiment, a door or window for instance one or more of the doors 1505 and windows 1504 shown in FIG. 15 may also be equipped with sensors to determine whether they are open or closed. This may further be used as part of the control of a building system as it may give greater confidence in the inference of other events for instance a person entering a room (by excluding the opening of a door or window when interpreting a detected change in temperature).

As for the embodiment described above in connection with FIG. 14, where multiple sensors are provided in separate rooms then occupancy information may be built up over time for each room and used to predict future occupancy patterns. This allows the building system to be controlled based on predicted future occupancy.

It is known for conventional building control systems to take account of building occupancy determined through different means. For instance, it is known for the control of building heating systems to use mobile phone data for devices associated with the occupants to determine through geofencing whether that person is in the building, and use this to turn the heating on or off appropriately. Advantageously, embodiments of the present invention provide for a significant increase in the precision of locating occupants by allowing them to be determined to be in particular rooms within the building. This allows building systems to be more precisely controlled, on a per room basis, which can have positive benefits for the building occupants in terms of comfort, safety, and cost of operating building systems.

According to a further embodiment of the present invention one or more sensor 1503 within a room 1502 may comprise a thermal sensor configured to detect heat sources as they pass through a sensor field of view. This allows movement of people through a building to be determined and further used to identify the rooms where people are located as part of controlling a building system. A sensor may also be configured to provide a measure of a distance to a thermal source within the field of view. This may further allow heat sources to be differentiated, for instance in the event that fixed heating appliances or sources of heat or heat loss (for instance, a window that may be opened) can be readily identified based on their known locations.

A further method of inferring events occurring within an indoor space according to an embodiment of the present invention will now be described.

The present inventor has identified that events occurring within an indoor space can be more accurately inferred through the combination of sensor data from two or more environment sensors that are located within the indoor space. The sensed environmental parameter may include temperature, pressure, humidity or any other parameter described in connection with the preceding embodiments. Changes in the outputs from two or more sensors may give rise to inferences of the nature of an event causing those changes. The events may be thermal, barometric, mechanical or related to third party parameters involving disturbances in the air composition such as humidity or chemical variations (gases) in the local atmosphere. There will now be described a mathematical treatment or processing of such sensor data. The multiple sensors may be collocated (or integrated into a single package) or they may be spaced apart within the indoor space (so long as each is located such that the sensed environmental parameter will be affected by the event it is desired to be able to detect). The sensors may be commercially available sensors or bespoke sensors. It will be appreciated that one approach to processing the sensor data from multiple sensors would be to adopt the same techniques described above whereby for each sensor the sensor data is processed to identify different regions and then for the region data to be aggregated across the group of sensors. However, in accordance with certain embodiments of the present invention a computationally simpler approach is adopted whereby for each of a sequence of time periods each sensor data stream is classified according to a limited number of states. A classification pattern may be established for each time period comprising the classification accorded to each sensor. A simple look up table approach may then adopted to infer whether an event has occurred (and the nature of the event) according to the classification pattern. The look up table may be established according to a calibration process substantially as previously described: in short, for different types of known events recording the associated classification pattern.

Each sensor may be substantially as described for sensor 101 illustrated in FIG. 1 and described above. Any suitable environment sensor may be used. The sensor data for each sensor may be processed to determine a classification for each time period in a computing device such as device 102 of FIG. 1. Each sensor 101 may have a separate associated or embedded computing device or processor 102 or sensor data from a plurality of sensors 101 may be processed by a single computing device or processor 102. In some cases, the classification of sensor data may be performed by a first processor or group of processors and the formation of a classification pattern performed by a second or further processor. Or, all processing of all sensor data may be performed by a single processor or computing device. The latter option may be particularly suited to the situation in which two or more environment sensors 101 are collocated or integrated together with a single processor for receiving and processing the data from each sensor.

Turning to FIG. 18, this illustrates in the form of a flowchart a method of inferring events within an indoor space. The method begins at step 1801 with the receipt of sensor data from two or more environment sensors within the indoor space. At step 1802 the sensor data is divided into a series of time periods. This may be a consecutive sequence of time periods. At step 1803 for each time period and for at least two environment sensors, a classification pattern is formed by classifying the sensor data for each sensor into two or more states. At step 1804, for each time period, the occurrence of an event within the indoor space the indoor space may be inferred based on the classification pattern. That is, the inference may be both whether an event has occurred and if so the nature of the event.

In more detail, step 1803 may comprise for each sensor classifying the sensor data into two or more states according to whether the sensor data is static (that is, has not changed through the time period by more than a threshold amount) or changing. In one example for each sensor the sensor data may be classified into three states comprising rising sensor data, falling sensor data or steady sensor data. Sensor data may be classified as rising sensor data if it increases by more than a first threshold during a time period. Sensor data may be classified as falling sensor data if it decreases by more than a second threshold during a time period. Otherwise, sensor data is classified as steady sensor data. The first and second threshold may be the same or may differ. Furthermore, the thresholds may be the same or different for each of the multiple sensors. Where each sensor is measuring the same environment parameter it may be that the thresholds applied to each sensor are the same. However, where different environment parameters are sensed it may be that different thresholds are to be applied.

In essence the method comprises detecting consecutive changes from a stable region of sensing followed by a new stable region. For a practical example whereby the event comprises a person entering a living space (for example, a room measuring 4 m×3 m) a combination of a temperature sensor and a pressure sensor may both be expected to show a step change from a first level to a second level that is approximately correlated in time. Note that either the pressure or temperature change may be positive or negative for any given event. Each sensor may be expected to experience a specific magnitude change. For each of a pressure sensor and temperature sensor we can identify three overall states (with the assumption that changes occur simultaneously) the states comprising rising ( [symbol] ), falling ( [symbol] ), or stable (<->). The nine possible state combinations for two sensors each having three different states are enumerated in Table 2 below.

TABLE 2

| | State | State | State | State | State | State | State | State | State |
|---|---|---|---|---|---|---|---|---|---|
| Parameter | 11 | 10 | 01 | 00 | —1 | —0 | 0— | 1— | — |
| Temperature | [symbol] | [symbol] | [symbol] | [symbol] | <-> | <-> | [symbol] | [symbol] | <-> |
| Pressure | [symbol] | [symbol] | [symbol] | [symbol] | [symbol] | [symbol] | <-> | <-> | <-> |

It will be appreciated that the example of three states is only one option. In a further embodiment one or more sensors may be classified into five states comprising rising sensor data, rapidly rising sensor data, falling sensor data, rapidly falling sensor data, or steady sensor data by comparing the sensor data to two different thresholds for rising sensor data and two different thresholds for falling sensor data. It may be that every sensor is classified according to the same number of states. However, a different number of states may be applied for different sensors. A further alternative falling within the scope of the present invention is that the number of states for one or more sensors may be varied when required for further detailed analysis. For instance, if a classification for a first number of states reveals the possibility of an event, the sensor data may be reclassified for that or a subsequent time period according to a larger, more detailed number of states.

The number of states and the appropriate thresholding for a group of sensors in order to accurately infer events may be established through a calibration process. Similarly, the optimal length of a time period in order to correctly infer an event can be determined through a calibration process. Each time period may be equal in length. The time period length may be selected to be longer than the time taken for an event to result in a sensor data change for each sensor. Alternatively, for a specific indoor space the length of each time period may be configurable according to the anticipated duration of events.

It will be appreciated that as the number of sensors and the number of states for each sensor increase the number of possible classification patterns will increase exponentially.

For the example of two sensors a succession of states may be experienced, as represented below in Table 3.

TABLE 3

| Parameter | Time period 1 | Time Period 2 | Time Period 3 |
|---|---|---|---|
| Temperature | <-> | [symbol] | <-> |
| Pressure | <-> | <-> | <-> |

The decision making process can relying on an encoding method whereby the states of the sensors are encapsulated within a digital representation which may act as a point to actual values allowing fast detection and identification. For example, a stable time period may be accorded 0, a rising time period accorded +1 and a falling time period accorded −1.

Suppose we have a sensor S in the state Si with possible sensing states or values for Si being −1, 0, 1. If we take the absolute value for three consecutive states (some seconds apart as a starting reference) for all the sensors 1 to N in the local network we get:

$$\vert {A}_{1} \vert = {\sum }_{i = 1}^{N} \vert {S}_{i , 1} \vert \qquad ( 8 )$$

$$\vert {A}_{2} \vert = {\sum }_{i = 1}^{N} \vert {S}_{i , 2} \vert \qquad ( 9 )$$

$$\vert {A}_{3} \vert = {\sum }_{i = 1}^{N} \vert {S}_{i , 3} \vert \qquad ( 10 )$$

The values obtained, if all sensors start from a position of rest then:

$$\begin{matrix}\vert {A}_{1} \vert = 0 & 0 <= \vert {A}_{2} \vert <= N & 0 <= \vert {A}_{3} \vert = N\end{matrix} \qquad ( 11 )$$

If all the sensors experience synchronous changes from the first state then:

$$\begin{matrix}{A}_{1} = 0 & \vert {A}_{2} \vert <= N & {A}_{3} = 0\end{matrix} \qquad ( 12 )$$

The state A₂ shows the number of state changes. The number of positive changes A₊ is equal to

$${A}_{+} = \frac{( \vert {A}_{2} \vert + {A}_{2} )}{2} \qquad ( 11 )$$

whereas the number of negative going changes (reductions) can be expressed as:

$${A}_{-} = \frac{( {A}_{2} - \vert {A}_{2} \vert )}{2} \qquad ( 12 )$$

A2 can be positive or negative. Accordingly, the number of changes can be used to determine whether there is a need to perform a look up table reference, thereby reducing the amount of processing in the event that no change (and hence, no event) has occurred.

As noted previously, a look up table approach may be followed to infer the nature of an event for a determined calibration process. More generally, the present invention may comprise for each time period, inferring an event by comparing the classification pattern to historical data comprising classification patterns for a plurality of known event types. The historical data is generated through a process of receiving sensor data during a plurality of known events within the indoor space and for each known event correlating the event to a classification pattern for a time period containing that event. A look up table is one suitable technique for efficiently storing the historical data.

It will be appreciated that particularly where an increased number of sensors or states is used, a determined classification pattern may not exactly match an entry within a look up table. In that event, the method may further comprise a process of interpolation to determine an inferred event from the closest matched entries in the look up table. The event inferred through interpolation and the associated classification pattern may then be used to update the look up table to include a further classification pattern associated with the interpolated event type. For instance, if the closest matched entry in the look up table is that a person has entered the indoor space then the look up table may be updated to include a further classification pattern matched to that event.

In a further extension, an event may be inferred based on classification patterns for two or more consecutive time periods. The reader will note the synergy between this and the previously described techniques for determining the occurrence of an event using a single sensor based on an identified sequence of two or more states. In some cases, including where the classification pattern is ambiguous, one or more sensors may be interrogated using the above described techniques for determining different sensor data regions in order to identify the nature of an event that has occurred.

Certain embodiments described above allow data obtained from an environmental sensor within a building (for instance, a home) to be processed to infer the state of an indoor space (for instance, a room within a home) containing that sensor. Furthermore, processing of the sensor data can be used to infer events that are occurring in that indoor space. For instance, for a temperature sensor, data processing can be used to identify when a heat source has entered or left the indoor space (or been turned on or off), and to infer the type of heat source event (for instance, if a person has entered or left the indoor space). It has been described how this real-time processing of sensor data (or quasi-real-time, in the sense that events are inferred by looking back through the recent history of the sensor data) can be used to control a building system. For the example of a temperature sensor, which may be low cost, data processing can be used to obtain occupancy information for the indoor space which can be used to improve the control of a heating system (for instance, by turning it off or reducing the level of the heating system if the room is unoccupied). It has been described how this may be extended, for instance through the deployment of multiple sensors within an indoor space or throughout a building (for instance, one in each room of a home) to provide for dynamic, real-time (or quasi-real-time) control of a building system, including on a room-by-room basis. It has also been described how this is extensible to different types of environment sensor.

The skilled person will appreciate the utility of being able to discern in quasi-real-time rich information about what is happening throughout a building, and how this may be used to improve the control of any number of building systems to provide for homes that are more comfortable and healthier for the occupants and more energy efficient. This rich information is obtained from low-cost environmental sensors that can be rapidly deployed in relatively large numbers through a home.

According to certain embodiments of the invention, as well as using this sensor data for quasi-real-time control of building systems, it will be appreciated that a rich data set may be built up over time comprising both environmental data (for instance, temperature data) that directly quantifies a measurable parameter of the building and also indoor space state, or event information, derived from that environmental data.

While the data set may include any type of event information, for understanding a buildings performance in some embodiments of the invention occupancy information may be particularly important. As discussed in the preceding description, changes in occupancy may be detected on a room by room basis by inferring when people enter and exit a room. By extension, an environmental sensor (particularly a temperature sensor) may be used to determine whether a room is occupied at a given time (or how many people are within the room) by tracking changes over time. This may require counting changes in occupancy from a known starting state, for instance that a room is unoccupied. This occupancy information may be correlated with the underlying environmental data. This may also be aggregated over a period of time. For instance, over a 24 hour period (or longer, such as a week, month, season, or year) average temperature (or other environmental parameter) during periods of time when the room or building is occupied may be compared with average temperature during periods of time when the room or building is unoccupied. In another example, an aggregate measure of a building environmental parameter may be established over first and second time periods (for instance year one and year two) and then the occupancy information queried to determine if there has been a change in occupancy patterns from one time period to the next. The occupancy information may be used to exclude the effect of a change in occupancy when assessing environmental sensor data to determine whether there has been a change in the building performance or the fabric of the building.

It will be appreciated that in some cases the processing to assess patterns in environmental data versus occupancy patterns for a single room or for a whole building may be performed within the building and the insights generated used locally. For instance, for an owner-occupied home that is equipped with suitable environmental sensors (for instance for controlling building systems such as a heating system, as described above) it may be that the owner can use the generated environmental data and the inferred occupancy information to detect changes in their own home's performance over time.

However, it will further be appreciated that where the owner or responsible party for a building is not the building occupant then advantageously the present invention allows that owner or responsible party to monitor the performance of the building (and if required, take action on the basis of the insights generated). Taking the example of a rented home, the landlord (such as a social housing association, otherwise referred to as a registered provider) may be responsible for the upkeep of the home (or multiple homes). It is known in the art to equip rented homes with environmental sensors including temperature and humidity sensors and to stream sensor data to a remote monitoring location (or periodically retrieve the sensor data, for instance by visiting the home and downloading sensor data). That sensor data may then be interrogated either continuously or periodically to seek to identify patterns in the data that may be indicative of faults in the fabric of the building requiring corrective action to be taken (including scheduling an appointment for a maintenance worker to visit for an in-person inspection). An example might be identifying changes in humidity levels within one or more rooms of a home that indicate the possible presence of mould. Certain embodiments of the present invention provide an extension to this remote monitoring by providing the landlord with an expanded data set that includes event information, for instance occupancy information, but this may be extended to include other factors such as whether doors and windows are open, when heating or cooling appliances are turned on and other events or indoor state information that may be inferred from environmental sensor data, as described above. This event information may permit more accurate assessment of potential changes in the performance of the building.

Where the data set transmitted to the landlord includes both environmental data and occupancy information, according to an embodiment of the present information, the occupancy information may be used to exclude the effects of a change in occupancy within the environmental data. As an example, if a room is occupied and the humidity rises during that period of occupancy, most likely this is simply due to expiration from occupants. However, if over a prolonged period of time, for instance a month, the humidity within a building or a single room within the building habitually rises during time periods when the room is known to be unoccupied then this may indicate an alternative source of moisture such as ingress from a bathroom. This may indicate that the building or room is at an increased risk of damp problems or mould growth, which may require further inspection or maintenance to take place.

As a further example, a landlord that builds and rents out homes will want to know how each building performs over time, and to exclude the effects of differing building occupancy patterns. This information may be used to optimise the selection of building materials for maintaining a desired climate, optimal building orientation, and optimal building systems, for instance types and distribution of heating appliances. Data from multiple homes (where the effects of differing building occupancy have been excluded) may be used to improve the design of future buildings for improved performance. This performance information may be fed back to the design process for building future homes.

A further example is that by monitoring both building environmental parameters and occupancy patterns over an extended time period, changes in building integrity may be identified. For instance, if energy consumption for a building increases from one year to the next, while accounting for any detected changes in occupancy patterns (for instance, an increase in home working) then this may indicate that there has been a material change in the fabric of the building requiring investigation (such as breach in the building insulation).

It will be appreciated that particularly in the case of a building being occupied by tenants and the building performance monitored by a landlord, there is a need to preserve the privacy of the building occupants. For examples of the present invention where patterns in building environmental parameters and occupancy are assessed over extended time periods, it may be that detailed occupancy information is unneeded. Average occupancy information, such as average daily occupancy across the course of a week, month, or year may be sufficient to exclude the effects of changes in occupancy patterns from detected changes in building performance. Alternatively, across each time period it may suffice to record average environmental data, for instance average temperature, for the proportion of the time when the building is occupied and the proportion of time when the building is unoccupied. Even with a minimum degree of occupancy information being recorded (which would not be personally identifiable) there may be a need for informed consent from building occupants to be monitored in this way. The benefit to the occupants may be that problems with the fabric of the building may be identified by the landlord and rectified sooner than might previously have been the case. This may lead to reduced energy bills, in addition to any benefits arising from improved control of building systems using the same sensors, as described above.

The data set may include time information. For instance, each sensor measurement may be time-stamped and inferred indoor space state and event information may be similarly time-stamped such that the inferred information and the underlying sensor data is correlated. The data set may derive from a single environmental sensor, or it may derive from multiple sensors, which may be multiple sensors of the same time distributed through the building or dissimilar sensor types. The type and location of each sensor may be recorded within the data set. Furthermore, the data set may include information concerning the dimensions, layout, or configuration of a room including an environment sensor, along with the location of the sensor within the room. The configuration of the room may include information about doors or windows opening onto the room including whether they can be opened, or information about building system components within the room, such as heating, air purifying, or ventilating devices. The data set may further include additional information about the building, including how the rooms are interlinked.

The data set may be supplemented with further data. For instance, it may include environmental data for the ambient environment surrounding the home, which may be directly measured, for instance with an external temperature sensor, or received from an external system such as weather data received via the internet. Further data that may be included may comprise occupancy information obtained in other ways, for instance through motion sensors or camera systems within the building or location data obtained through mobile devices associated within known users of the building.

A further example of data that may be included in the data set in some embodiments is the energy consumption of a building. This may be obtained directly from energy inputs to a building, for instance the amount of electrical energy delivered to the building per unit time, for instance hourly, per day, or a longer unit of time. This electrical energy may be received from a mains electricity connection or from local power generation (for instance, a photo-voltaic supply system). Similarly, the amount of gas delivered to and consumed by a building can be measured. Other energy sources for the building can be similarly measured.

Furthermore, energy consumed by specific building systems, such as a heating system, may be directly recorded, as well as operating times and levels for building systems. For instance, if the building includes a ventilation system, it may be recorded when the building or a room within a building is being ventilated.

From knowledge of how the temperature varies within a given living space (for instance, a single room, though this could be extended to a whole building) over a time period, this can be compared to the energy consumption for that room or building. That energy consumption may in some cases be only the energy directly consumed in heating or cooling the room or building. The two quantities are interrelated and may be correlated through a function that is specific to the space at hand. Alternatively, once the function has been established, an estimate of energy consumed by a room or a building may be formed by multiplying the established function for that room or building by the thermal profile data as an integral or sum over a given time period. The internal thermal heat generated and the energy consumed may be defined in terms of kilowatt hours (kwh). The efficiency of the room may then be expressed as Joules lost per kilowatt hour (per unit of time, for instance per month or per year). Where multiple rooms or a whole building are concerned, the result may be integrated across all of the rooms. This room or building efficiency information may be correlated with occupancy information to understand how occupancy may be a factor determining energy efficiency (including by taking account of the heating effect of people being present within a room or building).

When establishing the energy efficiency of a room or building by comparison of temperature data and energy consumption data (optionally accounting also for occupancy) in some embodiments account is also taken of the temperature outside of the building (that is, the ambient temperature). This is because the fabric of a building will lose heat to the ambient environment more rapidly if the temperature differential between inside and outside of the building is larger, regardless of how well insulted the building is. This can be corrected for in order to allow for more accurate assessments of building efficiency. Other factors that are significant when assessing building thermal efficiency (and hence may be directly measured and included within the data set) include the opening and closure of windows and doors (rates, times, and durations), and operation of heating, cooling, and ventilation devices (rates, times, and durations).

The data set that is built up for a building may be used to give an insight into how a building is performing over time. For example, a measure of the thermal insulation efficiency of a building may be established from comparison of energy delivered to the building, the interior temperature of the building and the ambient temperature. Further insights can be obtained dependent on the nature of the measured environmental parameters. For example, if temperature and humidity is tracked for a building or a room within a building over time, then a prediction can be made whether it is likely or not that damp or mould will be present within that building or room. In some cases, ventilation system operating information may also be relevant to determining the likelihood of damp or mould.

In some cases, the data set built up for a building may be processed to reduce its granularity. For instance, for the case of the temperature sensors discussed in previous embodiments, measurements may be as frequently as multiple times per second. However, this level of time precision may be unnecessary for gaining insights into how the building is performing over time. An averaging process may be performed such that environmental sensor data is recorded averaged per unit of time (for instance, per minute, hourly, daily, or a longer unit of time). Similarly, indoor space state and event information may be reduced in granularity. As an example, where occupancy information is obtained by measuring events relating to people entering or exiting a room, this may be recorded, for instance according to the proportion of each day that a room is occupied or an average room occupancy figure per unit time. This reduction in granularity for occupancy information may also be useful for privacy reasons (also noting that for the example of a temperature sensor, occupancy information can only indicate how many people are present, not their identities). Alternatively, or additionally, occupancy information can be reduced in granularity by calculating a proportion of a building that is occupied at a given instance (and optionally then calculating an average building occupancy per unit time) in place of determining occupancy information for each room of a building separately.

Insights regarding how a building is performing over time may be locally processed and locally provided. In some embodiments of the invention, the dataset of information may be fed (live or periodically) to a server remote from the building. In some cases, the full data set may be provided to the remote server. In other cases, some local processing occurs to reduce the granularity of the data to reduce the volume of data transmitted.

In some cases, information about how more than one building performs over time may be processed together. For the example of an estate of homes operated by a single organisation (for instance a housing association or registered provider), where homes are rented to the occupants, it may be desirable for the operator to be able to remotely receive information about the buildings are performing, such that the information can be interrogated on a per building basis. This may be used to identify issues with a particular building that needs to be addressed, for instance if the thermal performance of the building over time indicates that corrective action needs to be performed for building insulation. A further example could be where a likelihood of damp or mould is predicted for a building, then this could be remotely detected and used to trigger an inspection by an engineer.

In some embodiments of the invention, information for a plurality of similar building may be aggregated, which can provide valuable insights into how that type of building performs. These insights may be used to refine the design of future buildings, for instance by identifying from real-life examples where a type of building is thermally inefficient, such that future similar buildings should be design with more insulation. This also enables a comparison to be made between how different types of building such as different types of houses perform, again allowing for decisions on how houses may be modified in the future, for instance by specifying differing types of heating systems.

In some embodiments of the invention, data collection for environmental sensors deployed in buildings and data insights concerning building state and building events derived from the sensor data can be combined with other remote monitoring or control systems. For instance, remote fire monitoring systems are well established. It will be appreciated how the same remote monitoring infrastructure may be used to enable the remote data collection described above. In some embodiments of the invention, the environmental sensors described above may be collocated with fire detection systems, for instance smoke or heat detectors. This may be particularly advantageous for fire detection systems that use mains powered smoke or heat detectors as this provides a ready source of power for the environmental sensor and any embedded processor that provides pre-processing before the data is reported to a central location.

As noted previously, an environmental sensor may produce sensor data at rates ranging from a fraction of a second. However, for understanding the behaviour of a building over a longer time frame, it may be desirable to produce a simple average over a pre-set duration. This pre-set duration can yield averaged data over concatenated intervals stretching over a minute, an hour, a day, a week, a month, a year or as needed. The averaging may be of the unbiased type. As well or instead the sensor data may be integrated over the pre-set duration. For the example of a temperature sensor, the integration value obtained is proportional to the actual heat performance of the investigated space. Such integration data, for a thermal sensor, permits thermal variations within a room to be identified which can be used to understand how the room under analysis performs energetically. Therefore, averaging over these periods of time yields useful and important information on the performance of the living spaces with respect to heat retention, gains, and losses. The analysis of the thermal variations provides builders, developers, and owners of such spaces to take relevant actions, improve build quality, produce heat efficient designs, and reduce energy costs. Models can henceforth be produced so that the energy footprint of such dwellings is predicted and elucidated with respect to energy efficiency and costs. Further, this information collected over numerous dwellings can be valuable for future planners, builders, and energy suppliers.

The process of reducing the granularity of sensor data, for the example of a temperature sensor, through an averaging process will now be described analytically. A similar approach may be followed for reducing the granularity of occupancy information. Where the data set is transmitted from the home, for instance for analysis by a landlord, the process of reducing granularity of the data set may be performed within the building prior to its transmission to reduce the amount of transmitted data and to protect the privacy of the building occupants.

For this example, it may be supposed that temperature Ti is measured at a granularity of 1 Hz.

A succession of temperature measurements Ti may be recorded, with the index i indicating the measurement instance. Averaging the temperature over one minute (T_{m-Av}) (from an arbitrary start) is performed according to equation (13) below:

$${T}_{m - Av ( 1 )} = \frac{1}{60} {\sum }_{i = 1}^{i = 60} ( {T}_{i} ) \qquad ( 13 )$$

$${T}_{m - Av ( 2 )} = \frac{1}{60} {\sum }_{i = 61}^{i = 120} ( {T}_{i} )$$

$$Etc .$$

Similarly, for temperature data averaged over an interval of one hour (T^{h-Av}), this is performed according to equation (14) or equation (15) below:

$${T}_{h - Av ( 1 )} = \frac{1}{3600} {\sum }_{i = 1}^{i = 360} ( {T}_{t} ) \qquad ( 14 )$$

$${T}_{h - Av ( 1 )} = \frac{1}{60} {\sum }_{i = 1}^{i = 60} ( {T}_{m - A ν ( t )} ) \qquad ( 15 )$$

Similarly, for temperature data averaged over an interval of one day (T^{D-Av}), this is performed according to equation (16) below:

$${T}_{D - Av ( 1 )} = \frac{1}{24} {\sum }_{i = 1}^{i = 24} ( {T}_{h - Aν ( i )} ) \qquad ( 16 )$$

Similarly, for temperature data averaged over an interval of one month (T_{M-Av}), this is performed according to equation (17) below:

$${T}_{M - Av ( 1 )} = \frac{1}{31} {\sum }_{i = 1}^{i = 31} ( {T}_{D - A ( i )} ) \qquad ( 17 )$$

Referring now to FIG. 18, this flowchart illustrates a method of monitoring a building according to an embodiment of the present invention. At step 1801 the method begins with an environment sensor measuring an environmental parameter within a room within a building, and a processor receiving sensor data from the environment sensor within a room. The method of FIG. 18 is illustrated in connection with a single sensor in a single room within a building, however it will be appreciated that there may be a plurality of sensors distributed across multiple rooms within the building. The building may be a home. The sensor may be one of the types of sensors discussed previously, for instance a temperature sensor.

The processor may be located within the building or otherwise associated with the building. This may particularly be the case when the same sensor data and inferred room states or events are used to control one or more building systems within the building, as described earlier in this patent specification. However, the present invention encompasses the option for all processing of sensing data to be performed remotely (as well as the option for all processing to be performed locally to the building or any split between local and remote processing). At step 1802 the processor infers at least one of a room state or an event occurring within the room where the sensor is located. This inference may be performed as previously described in this document. The inference of a room state or an event may be performed for each sensor separately or sensor data from multiple sensors may be aggregated to perform the inference.

At step 1803 the processor forms a data set including the sensor data and inferred room states or events. Although not specifically illustrated in FIG. 18, the processor associated with the building may perform some initial data processing when forming the data set, including reducing the granularity of the sensor data and/or the room state or event information. The processor may further supplement the data set with the other data types discussed above.

At step 1804 the data set is analysed to monitor building condition or performance. This analysis may make use of any portion of the data set. As an example, the environmental sensor data may be analysed to identify building performance or to identify potential problems with the fabric of the building, while excluding the effects of changes in building occupancy. The processing at step 1804 may be performed by the same processor responsible for steps 1802 and 1803. That is, the whole of the method of FIG. 18 may be performed locally to the building being monitored.

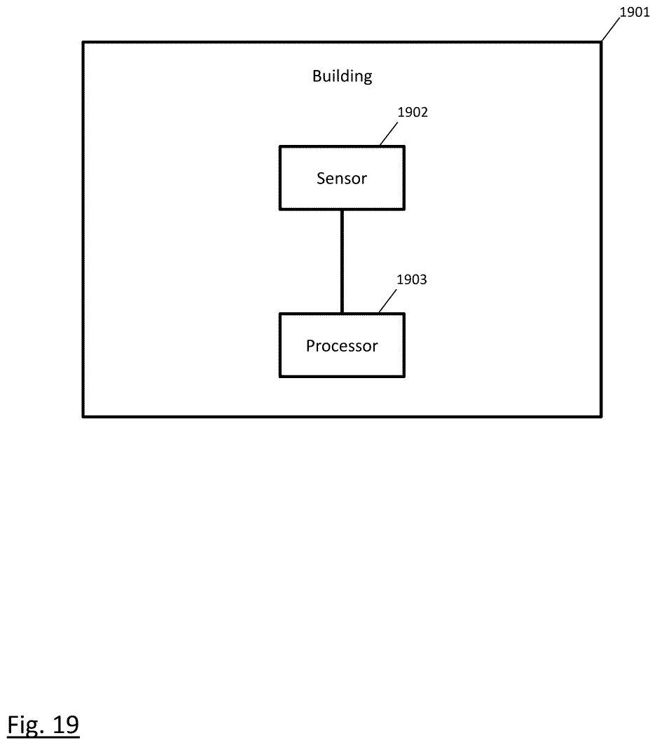

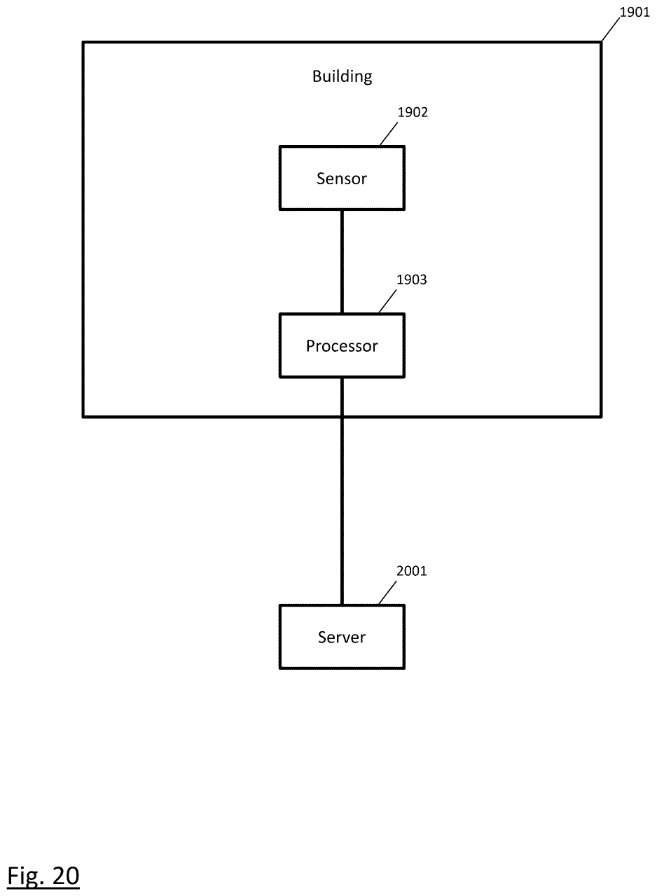

FIG. 19 schematically illustrates a system within a building 1901 comprising at least one sensor 1902 and a processor 1903 that is responsible for the processing of FIG. 18. Alternatively, prior to step 1804 the building processor 1903 may transmit the data set to a remote server 2001 as shown in the alternative system diagram of FIG. 20. As previously discussed, the system of FIG. 20 is particularly applicable to a situation in which the owner or responsible party for a building is different from the occupants of the building, for instance where a landlord remotely monitors the performance of one or more rented buildings.

It will be understood that for both FIGS. 19 and 20 there may be multiple sensors 1902 distributed through the building 1903 communicating with one or more processors 1903. That is, a single processor 1903 may perform at least some processing of sensor data from one or multiple sensors 1902. Alternatively, there may be a one to one relationship between sensor 1902 and processors 1903. The arrangement of processor 1903 and server 2001 is merely one example. The skilled person will appreciate that the method steps of FIG. 18 may suitably be distributed amongst one or more locally or remotely provided processor or server. For instance, in some cases a sensor may transmit all sensor data directly to a remote server such that no data processing takes place within the building at all.

It will be appreciated that examples of the present invention can be realized in the form of hardware, software or a combination of hardware and software. Any such software may be stored in the form of volatile or non-volatile storage, for example a storage device like a ROM, whether erasable or rewritable or not, or in the form of memory, for example RAM, memory chips, device, or integrated circuits or on an optically or magnetically readable medium, for example a CD, DVD, magnetic disk, or magnetic tape or the like. It will be appreciated that the storage devices and storage media are examples of machine-readable storage that are suitable for storing a program or programs comprising instructions that, when executed, implement examples of the present invention.

Accordingly, examples provide a program comprising code for implementing apparatus or a method as claimed in any one of the claims of this specification and a machine-readable storage storing such a program. Still further, such programs may be conveyed electronically via any medium, for example a communication signal carried over a wired or wireless connection and examples suitably encompass the same.

Throughout this specification, the words “comprise” and “contain” and variations of them mean “including but not limited to”, and they are not intended to (and do not) exclude other components, integers, or steps. Throughout this specification, the singular encompasses the plural unless the context otherwise requires. In particular, where the indefinite article is used, the specification is to be understood as contemplating plurality as well as singularity, unless the context requires otherwise. Throughout this specification, the term “about” is used to provide flexibility to a range endpoint by providing that a given value may be “a little above” or “a little below” the endpoint. The degree of flexibility of this term can be dictated by the particular variable and can be determined based on experience and the associated description herein.

Features, integers, or characteristics described in conjunction with a particular aspect or example of the invention are to be understood to be applicable to any other aspect or example described herein unless incompatible therewith. All of the features disclosed in this specification, and/or all of the steps of any method or process so disclosed, may be combined in any combination, except combinations where at least some of such features and/or steps are mutually exclusive. The invention is not restricted to the details of any foregoing examples. The invention extends to any novel feature or combination of features disclosed in this specification. It will also be appreciated that, throughout this specification, language in the general form of “X for Y” (where Y is some action, activity or step and X is some means for carrying out that action, activity, or step) encompasses means X adapted or arranged specifically, but not exclusively, to do Y.

Each feature disclosed in this specification may be replaced by alternative features serving the same, equivalent, or similar purpose, unless expressly stated otherwise. Thus, unless expressly stated otherwise, each feature disclosed is one example only of a generic series of equivalent or similar features.

The reader's attention is directed to all papers and documents which are filed concurrently with or previous to this specification in connection with this application and which are open to public inspection with this specification, and the contents of all such papers and documents are incorporated herein by reference.

1. A method of inferring events within an indoor space, the method comprising:
receiving sensor data from an environment sensor within the indoor space;
identifying regions within the received sensor data, each region comprising:
a stable region indicative of a period of time within which the received data does not vary by more than a magnitude threshold;
a trend region indicative of a period of time within which the received data trends upwards or downwards with a sensor data gradient less than a gradient threshold; or
a rapid change region indicative of a period of time within which the received data trends upwards or downwards with a sensor data gradient greater than or equal to the gradient threshold; and
inferring an event occurring within the indoor space based on an identified sequence of two or more identified regions.

2. A method according to claim 1, wherein the inference is based on a calibration method comprising:
receiving sensor data from the environment sensor within the indoor space during a plurality of known events within the indoor space;
identifying regions within the received sensor data, each region comprising:
a stable region indicative of a period of time within which the received data does not vary by more than a magnitude threshold;
a trend region indicative of a period of time within which the received data trends upwards or downwards with a sensor data gradient less than a gradient threshold; or
a rapid change region indicative of a period of time within which the received data trends upwards or downwards with a sensor data gradient greater than or equal to the gradient threshold; and
correlating an identified sequence of regions within the sensor data to those known events within the indoor space.

3. A method according to claim 1, wherein prior to the step of identification the method further comprises filtering the sensor data.

4. A method according to claim 3, wherein the filtering comprising noise reduction and removal of fluctuations not indicative of change within the indoor space.

5. A method according to claim 3, wherein the filtering comprises passing the sensor data through a weighted window processing filter.

6. A method according to claim 1, wherein prior to the step of identification the method further comprises curve fitting the sensor data or filtered sensor data to a polynomial curve.

7. (canceled)

8. A method according to claim 1, wherein identifying a stable region, trend region or rapid change region comprises processing the sensor data, filtered sensor data or curve fitted sensor data using a region weighting mathematical expression.

9. A method according to claim 1, wherein for at least one identified stable region the method further comprises:
identifying a sensor data magnitude or an average sensor data magnitude within the identified stable region;
identifying a sensor data magnitude band containing the sensor data magnitude or average magnitude; and
inferring an indoor space state based on the identified sensor data magnitude band;
wherein the inference of an indoor space state is based on a calibration method comprising measuring sensor data magnitudes for a plurality of known indoor space states and determining sensor data magnitude bands for those known indoor space states.

10. A method according to claim 8, wherein for at least one trend region the method further comprises:
inferring that no event has occurred within the indoor space state or that the indoor space remains within a previously identified indoor space state based on a calibration method comprising measuring sensor data magnitudes for a plurality of known indoor space states and determining expected data trends or drifts in sensor data for those known indoor space states over time.

11. A method according to claim 1, wherein inferring an event occurring within the indoor space further comprises:
for at least one identified rapid change region:
identifying a sensor data gradient or an average sensor data gradient within the identified rapid change region; and
identifying a sensor data gradient band containing the sensor data gradient or average gradient; and
wherein the inference of an event that has occurred within the indoor space is further based on a calibration method of measuring sensor data gradients for a plurality of known events within the indoor space and determining sensor data gradient bands for those known events within the indoor space.

12. A method according to claim 10, wherein inferring an event that has occurred within the indoor space is further based upon an identified sequence of two or more different rapid change regions.

13. A method according to claim 11, wherein inferring an event that has occurred within the indoor space is further based upon an identified sequence of two or more different rapid change regions having opposite polarity sensor data gradients.

14. A method according to claim 1, wherein the environment sensor comprises:
a temperature sensor;
a pressure sensor;
a humidity sensor; or
a gas sensor.

15. A method according to claim 13, wherein where the environment sensor is a temperature sensor located within the indoor space, an inferred indoor space state comprises a state in which the number of heat sources and heat sinks within the indoor state remains static.

16. A method according to claim 13, wherein where the environment sensor is a temperature sensor located within the indoor space, an inferred event that has occurred within the indoor space comprises one of:
a heat source entering or being activated in the indoor space; or
a loss of heat being triggered in the room.

17. A method according to claim 15, wherein a heat source entering or being activated in the indoor space comprises:
an artificial heating system being activated within the indoor space; or
a person or animal entering the indoor space.

18. A method according to claim 15, wherein a loss of heat being triggered in the room comprises:
an artificial cooling system being activated in the indoor space;
an artificial heating system being deactivated within the indoor space;
an aperture, for instance a door or window, being opened allowing warm air to vent from the indoor space; or
a person or animal leaving the indoor space.

19. A method according to claim 1, wherein the indoor space comprises a room in a building.

20. (canceled)

21. (canceled)

22. A sensing system for inferring events within an indoor space, the system comprising:
an environment sensor configured to generate sensor data indicative of an environment parameter within the indoor space; and
a computing device configured to:
receive sensor data from the environment sensor;
identify regions within the received sensor data, each region comprising:
a stable region indicative of a period of time within which the received data does not vary by more than a magnitude threshold;
a trend region indicative of a period of time within which the received data trends upwards or downwards with a sensor data gradient less than a threshold gradient; or
a rapid change region indicative of a period of time within which the received data trends upwards or downwards within a sensor data gradient greater than or equal to a threshold gradient; and
infer an event occurring within the indoor space based on an identified sequence of two or more identified regions.

23. A method for calibrating a method of inferring events within an indoor space, the method comprising:
receiving sensor data from an environment sensor within the indoor space during a plurality of known events within the indoor space;
identifying regions within the received sensor data, each region comprising:
a stable region indicative of a period of time within which the received data does not vary by more than a magnitude threshold;
a trend region indicative of a period of time within which the received data trends upwards or downwards with a sensor data gradient less than a gradient threshold; or
a rapid change region indicative of a period of time within which the received data trends upwards or downwards with a sensor data gradient greater than or equal to the gradient threshold;
and
correlating an identified sequence of regions within the sensor data to known events within the indoor space.

24. (canceled)

25. (canceled)

26. (canceled)

27. (canceled)

28. (canceled)

29. (canceled)

30. (canceled)

31. (canceled)

32. (canceled)
